(19) United States
(12) Patent Application Publication
(10) Pub. No.: US 2018/0047194 A1
(43) Pub. Date: Feb. 15, 2018

(54) INFORMATION OUTPUT SYSTEM, INFORMATION OUTPUT METHOD, AND INFORMATION OUTPUT PROGRAM

(71) Applicant: SEIKO EPSON CORPORATION, Tokyo (JP)

(72) Inventors: Tsubasa SHIRAI, Shiojiri-shi (JP); Tomoyuki KURATA, Matsumoto-shi (JP)

(73) Assignee: SEIKO EPSON CORPORATION, Tokyo (JP)

(21) Appl. No.: 15/668,393

(22) Filed: Aug. 3, 2017

(30) Foreign Application Priority Data
Aug. 12, 2016 (JP) 2016-158886

(51) Int. Cl. G06T 11/60; A63B 24/00; G06T 11/20; A63B 71/06; G06T 17/05; G06T 11/00

(52) U.S. Cl. CPC G06T 11/60; G06T 17/05; G06T 11/001; G06T 11/203; A63B 71/0622; A63B 24/0021; A63B 24/0062; G06F 3/0482

(57) ABSTRACT

An information output system includes a display section that displays at least one geographic route along which a physical activity has been performed by a user of the information output system; and a processor that performs control of displaying at least a part of the at least one geographic route with a visual expression corresponding to a type of the physical activity performed in the part, different visual expressions being used to indicate different types of physical activity.

### INCORPORATION BY REFERENCE

This application claims the priority benefit of Japanese Patent Application 2016-158886, the disclosure of which is hereby incorporated herein by reference in its entirety.

### BACKGROUND

### 1. Technical Field

The present invention relates to an information output system, an information output method, and an information output program.

### 2. Related Art

With the recent health boom, the interest of the general public has been steadily increasing toward the health. Under such circumstances, products, electronic apparatuses, and services which support users from both aspects of life and exercise have appeared, and play a part in the market for wearable apparatuses and wearable services. Analysis and advice which match each individual are required for wearable apparatuses or wearable services.

The Specification of US-A-2010/0057951 discloses a system which displays an exercise path of a user, and also discloses an example in which an expression of performance data is changed according to the user's heart rate (so-called a heart rate zone).

However, even if displayed heart rates are the same as each other, the performance of a user may greatly differ, for example, in cases where an activity performed by the user is walking and jogging, and thus there is room for improvement of the user's convenience.

### SUMMARY

An advantage of some aspects of the invention is to provide an information output system, an information output method, and an information output program, which are highly convenient and can present a route on which a user performs an activity to the user in an easily understandable form.

The invention can be implemented as the following forms or application examples.

### APPLICATION EXAMPLE 1

An information output system according to this application example includes a display section that displays at least one route in which an activity has been performed; and a processor that performs control of displaying at least a part of at least one route with a visual expression corresponding to the type of activity performed in the part.

Since the display section displays at least one route in which an activity has been performed, and the processor performs control of displaying at least a part of at least one route with a visual expression corresponding to the type of activity performed in the part, a user can determine the type of activity performed in at least a part of the route on the basis of a visual expression of the part. Therefore, the user can easily visually check the type of activity performed in the part.

### APPLICATION EXAMPLE 2

In the information output system according to the application example, at least one route may include a first route corresponding to a first activity and a second route, different from the first route, corresponding to a second activity, the first route may be displayed by a first visual expression corresponding to the type of first activity, and the second route may be displayed by a second visual expression corresponding to the type of second activity.

Since the information output system displays the first route corresponding to the first activity with the first visual expression, and displays the second route corresponding to the second activity with the second visual expression, a user can easily check the activity performed in the first route and the activity performed in the second route.

### APPLICATION EXAMPLE 3

In the information output system according to the application example, at least one route may include a first section corresponding to a first activity and a second section corresponding to a second activity, the first section may be displayed by a first visual expression corresponding to the type of first activity, and the second section may be displayed by a second visual expression corresponding to the type of second activity.

Since the information output system displays the first section corresponding to the first activity with the first visual expression, and displays the second section corresponding to the second activity with the second visual expression, a user can easily check the activity performed in the first section and the activity performed in the second section.

### APPLICATION EXAMPLE 4

In the information output system according to the application example, the display section may display at least one route on a map in an overlapping manner.

Since the display section displays a recommended route on the map in an overlapping manner, a user can check both a geographical situation of an area in which the route is present and the activity performed in the route.

### APPLICATION EXAMPLE 5

In the information output system according to the application example, the map may be at least one of a two-dimensional map including at least a part of at least one route, a three-dimensional map including at least a part of at least one route, and a map indicating an elevation of at least a part of at least one route.

Therefore, a user can check at least one of a two-dimensional map including at least a part of the route, a three-dimensional map including at least a part of the route, and a map indicating an elevation of at least a part of the route, along with the activity performed in the route.

### APPLICATION EXAMPLE 6

An information output method according to this application example includes displaying at least one route in which an activity has been performed; and performing control of displaying at least a part of at least one route with a visual expression corresponding to the type of activity performed in the part.

In the information output method according to the application example, since at least one route in which an activity has been performed is displayed, and a processor performs control of displaying at least a part of at least one route with a visual expression corresponding to the type of activity performed in the part, an information output system can recognize the type of activity performed in at least a part of the route on the basis of a visual expression of the part. Therefore, a user can easily visually check the type of activity performed in the part.

### APPLICATION EXAMPLE 7

An information output program according to this application example causes a computer to execute displaying at least one route in which an activity has been performed; and performing control of displaying at least a part of at least one route with a visual expression corresponding to the type of activity performed in the part.

According to the information output program related to the application example, the computer displays at least one route in which an activity has been performed, and a processor performs control of displaying at least a part of at least one route with a visual expression corresponding to the type of activity performed in the part, an information output system can recognize the type of activity performed in at least a part of the route on the basis of a visual expression of the part. Therefore, a user can easily visually check the type of activity performed in the part.

### BRIEF DESCRIPTION OF THE DRAWINGS

The invention will be described with reference to the accompanying drawings, wherein like numbers reference like elements.

FIG. 1 is a diagram illustrating a configuration example of a system.

FIG. 2 is a functional block diagram illustrating a configuration example of an electronic apparatus.

FIG. 3 is a functional block diagram illustrating configuration examples of an information terminal and a server.

FIG. 4 is a diagram illustrating an example of an input screen for a fatigue degree.

FIG. 5 is a diagram illustrating another example of an input screen for a fatigue degree.

FIG. 6 is a diagram illustrating still another example of an input screen for a fatigue degree.

FIG. 7 is a diagram illustrating still another example of an input screen for a fatigue degree.

FIG. 8 is a diagram illustrating an example of a body condition table.

FIG. 9 is a diagram illustrating an example of log data.

FIG. 10 is a diagram illustrating a detailed example of log data.

FIG. 11 is a diagram illustrating an example of autonomic nervous data.

FIG. 12 is a diagram illustrating an example of a mental balance measurement method.

FIG. 13 is a flowchart illustrating an example of a deviation calculation process.

FIG. 14 is a flowchart illustrating an example of a learning process.

FIG. 15 is a diagram illustrating an example of heart rate data for each training event.

FIG. 16 is a diagram illustrating an example of feature data for each training event.

FIG. 17 is a diagram illustrating an example of a display screen (list display) for recommended events.

FIG. 18 is a diagram illustrating an example of a display screen (map display) for recommended courses.

FIG. 19 is a diagram illustrating an example of a display screen (map display) for recommended events.

FIG. 20 is a diagram illustrating an example of a display screen for recommended menus.

FIG. 21 is a diagram illustrating an example of a display screen (elevation difference display) for recommended courses.

FIG. 22 is a diagram illustrating an example of an operation in which a user activates an application.

FIG. 23 is a diagram illustrating an example of an operation in which the user selects a course.

FIG. 24 is a diagram illustrating an example of a navigation screen.

FIGS. 25A and 25B are diagrams illustrating examples of navigation screens.

FIG. 26 is a diagram illustrating another example of a navigation screen.

FIG. 27 is a diagram illustrating still another example (gray-out) of a navigation screen.

FIG. 28 is a diagram illustrating still another example (map display) of a navigation screen during running.

FIG. 29 is a diagram illustrating course data.

FIG. 30 is a flowchart illustrating an example of a course recommendation process.

FIG. 31 is a diagram illustrating an example of a feedback screen.

FIG. 32 is a diagram illustrating an example of a training event determination process (overall).

FIG. 33 is a diagram illustrating an example of a training event determination process (details).

FIG. 34 is a diagram illustrating another example of a feedback screen.

FIG. 35 is a diagram illustrating still another example (map display) of a feedback screen.

FIG. 36 is a diagram illustrating a still another example of a feedback screen (elevation map).

FIG. 37 is a diagram illustrating still another example of a feedback screen (map display).

FIG. 38 is a diagram illustrating an example of a course-out determination process.

### DESCRIPTION OF EXEMPLARY EMBODIMENTS

Hereinafter, preferred embodiments of the invention will be described in detail with reference to the drawings. The embodiments described below are not intended to improperly limit the content of the invention disclosed in the appended claims. In addition, all constituent elements described below are not essential constituent elements of the invention.

### 1. System of Present Embodiment

### 1-1. Overview of System

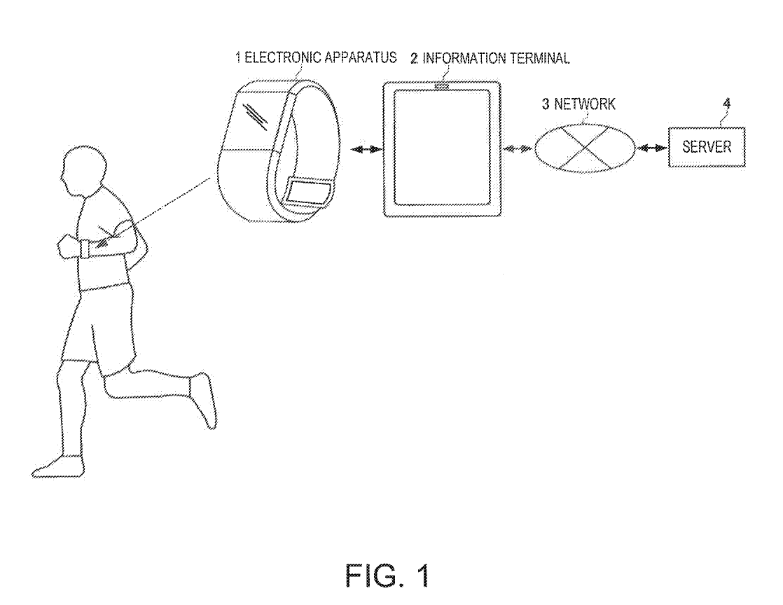

As illustrated in FIG. 1, an information output system (hereinafter, simply referred to as a “system”) of the present embodiment includes, for example, a wearable electronic apparatus 1, a portable information terminal 2 connected to a network 3, and a server 4 connected to the network 3. A user of the electronic apparatus 1 is the same as a user of the information terminal 2, and the electronic apparatus 1 and the information terminal 2 can timely perform communication with each other through short-range radio communication or the like. The information terminal 2 can perform communication with the server 4 via the network 3 such as the Internet. An information terminal (not illustrated) used by another user is connected to the network 3, and the information terminal can perform communication with an electronic apparatus (not illustrated) of another user through short-range radio communication or the like.

The electronic apparatus 1 of the user has at least one of a function (life logger function) of recording (logging) data regarding the user's life, and a function (performance monitor function) of recording (logging) data regarding the user's exercise. The electronic apparatus of another user has at least one of the life logger function and the performance monitor function. However, herein, the electronic apparatus 1 of the user is assumed to have both of the life logger function and the performance monitor function, and, hereinafter, the electronic apparatus 1 will be focused.

The electronic apparatus 1 is a wearable portable information apparatus mounted on a part of the user's body. A mounting location of the electronic apparatus 1 is, for example, a part (forearm) from the elbow to the hand so that the user can view the electronic apparatus when necessary. In the example illustrated in FIG. 1, the electronic apparatus 1 is formed as a wrist type (wristwatch type) portable information apparatus, and has a belt which is a mounting tool for mounting the electronic apparatus on the wrist of the user. For example, one or a plurality of operation sections formed of mechanical switches may be provided on an outer edge portion of a display section of the electronic apparatus 1. The display section of the electronic apparatus 1 is formed of a touch panel type display, and the touch panel display may function as an operation section. The electronic apparatus 1 has the life logger function and the performance monitor function in addition to a clocking function, and thus the electronic apparatus 1 has various sensing functions for acquiring data regarding the life or exercise from the user's body. Hereinafter, data (data regarding the life or exercise) which is acquired from the user's body and is recorded in the electronic apparatus 1 will be referred to as “log data”.

The information terminal 2 is an information terminal such as a smart phone, a tablet personal computer (PC), or a desktop PC which can be connected to the network 3 such as the Internet, but is here assumed to be a portable information terminal which is carried by the user along with the electronic apparatus 1. The information terminal 2 is used to transmit data which is received from the server 4 via the network 3 to the electronic apparatus 1, or to read log data written to a storage section of the electronic apparatus 1 and to upload the log data to the server 4 via the network 3. Some or all of the functions of the information terminal 2 may be installed in the electronic apparatus 1 side.

### 1-2. Configuration of Electronic Apparatus

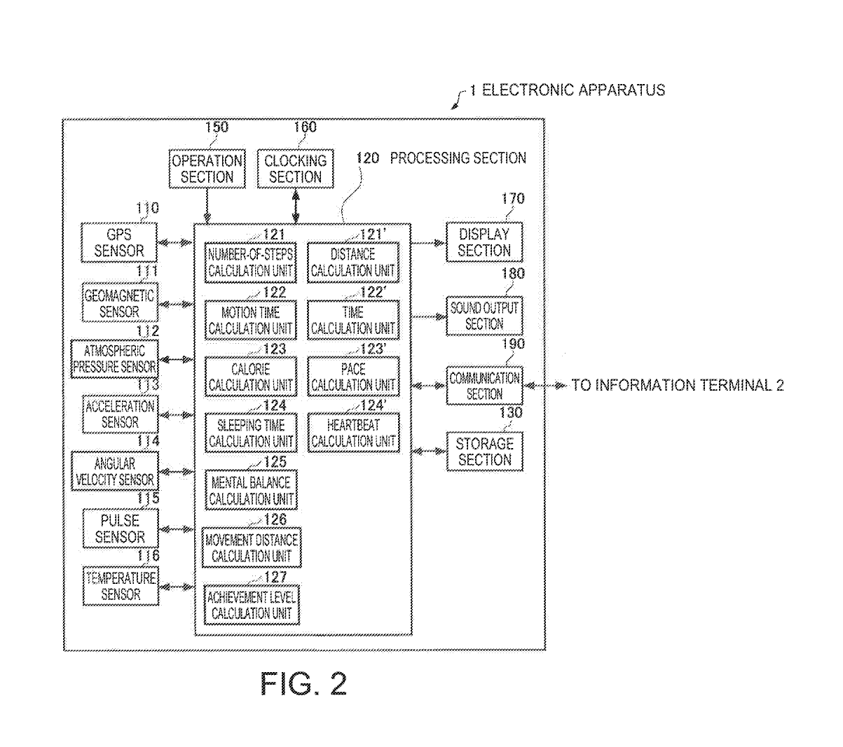

As illustrated in FIG. 2, the electronic apparatus 1 is configured to include a global positioning system (GPS) sensor 110 (an example of a position sensor), a geomagnetic sensor 111 (an example of an azimuth sensor), an atmospheric pressure sensor 112, an acceleration sensor 113, an angular velocity sensor 114, a pulse sensor 115, a temperature sensor 116, a processing section 120 (also referred to as a processor), a storage section 130, an operation section 150, a clocking section 160, a display section 170 (an example of an output section), a sound output section 180 (an example of an output section), a communication section 190, and the like. However, the electronic apparatus 1 may have a configuration in which some of the constituent elements are deleted or changed, or may have a configuration in which other constituent elements (for example, a humidity sensor and an ultraviolet sensor) are added thereto.

The GPS sensor 110 is a sensor which generates positioning data indicating a position and the like (data such as latitude, longitude, altitude, velocity vector, and the like) of the electronic apparatus 1 and outputs the data to the processing section 120, and is formed of, for example, a global positioning system (GPS) receiver. The GPS sensor 110 receives an electric wave with a predetermined frequency bandwidth incoming from the outside by using a GPS antenna (not illustrated), extracts a GPS signal sent from a GPS satellite therefrom, and also generates positioning data indicating a position or the like of the electronic apparatus 1 on the basis of the GPS signal.

The geomagnetic sensor 111 is a sensor which detects a geomagnetic vector indicating a direction of a magnetic field of the earth, viewed from the electronic apparatus 1, and generates, for example, geomagnetic data indicating magnetic flux densities in three-axis directions which are orthogonal to each other. For example, a magnet resistive (MR) element, a magnet impedance (MI) element, or a hole element is used for the geomagnetic sensor 111.

The atmospheric pressure sensor 112 is a sensor which detects an ambient atmospheric pressure (atmospheric pressure), and includes, for example, a pressure sensitive element of a type (vibration type) using a change in a resonance frequency of a vibrator element. The pressure sensitive element is a piezoelectric vibrator made of a piezoelectric material such as quartz crystal, Lithium Niobate, or Lithium Tantalate, and employs, for example, a tuning fork type vibrator, a dual-tuning fork type vibrator, an AT vibrator (thickness shear vibrator), or a surface acoustic wave (SAW) vibrator. An output from the atmospheric pressure sensor 112 may be used to correct positioning data.

The acceleration sensor 113 is an inertial sensor which detects respective accelerations in the three-axis directions which intersect (are ideally orthogonal to) each other, and outputs digital signals (acceleration data) corresponding to magnitudes and directions of the detected three-axis accelerations. The outputs from the acceleration sensor 113 may be used to correct position information included in the positioning data from the GPS sensor 110.

The angular velocity sensor 114 is an inertial sensor which detects respective angular velocities in the three-axis directions which intersect (are ideally orthogonal to) each other, and outputs digital signals (angular velocity data) corresponding to magnitudes and directions of the detected three-axis angular velocities. The outputs from the angular velocity sensor 114 may be used to correct position information included in the positioning data from the GPS sensor 110.

The pulse sensor 115 is a sensor which generates a signal indicating a pulse of the user and outputs the signal to the processing section 120, and includes, for example, a light source such as a light emitting diode (LED) light source which applies measurement light having an appropriate wavelength toward a blood vessel under the skin, and a light receiving element which detects a change in the intensity of light generated at the blood vessel according to the measurement light. A light intensity change waveform (pulse wave) is processed according to a well-known method such as frequency analysis, and thus a pulse rate (a pulse rate per minute) can be measured. As the pulse sensor 115, instead of the photoelectric sensor formed of the light source and the light receiving element, an ultrasonic sensor which measures a pulse rate by detecting contraction of a blood vessel by using an ultrasonic wave, or a sensor which measures a pulse rate by causing a weak current to flow into the body, may be employed. A pulse is used to indirectly measure a heartbeat on the basis of pulsation of parts other than the heart in the user's body. Therefore, in the present specification, the term “pulse” may be replaced with the term “heartbeat”.

The temperature sensor 116 is a temperature sensing element which outputs a signal (for example, a voltage corresponding to a temperature) corresponding to an ambient temperature. The temperature sensor 116 may output a digital signal corresponding to a temperature. The temperature sensor 116 may include not only a sensor detecting the ambient temperature of the user but also a sensor detecting the temperature (body temperature) of the user's body.

The processing section 120 (an example of an acquisition section) is formed of, for example, a micro processing unit (MPU), a digital signal processor (DSP), and an application specific integrated circuit (ASIC). The processing section 120 performs various processes according to a program stored in the storage section 130, and various commands which are input by the user via the operation section 150. The processes in the processing section 120 include, for example, data processing on data which is generated by the GPS sensor 110, the geomagnetic sensor 111, the atmospheric pressure sensor 112, the acceleration sensor 113, the angular velocity sensor 114, the pulse sensor 115, the temperature sensor 116, the clocking section 160, and the like, display processing (an example display control) for displaying an image on the display section 170, sound output processing for outputting sounds from the sound output section 180. The “processing section” will be referred to as a “processor” in some cases. The processing section 120 may be formed of a single processor, and may be formed of a plurality of processors.

The storage section 130 is formed of, for example, one or a plurality of integrated circuit (IC) memories, and includes a read only memory (ROM) storing data such as a program (an example of an information output program), and a random access memory (RAM) serving as a work region of the processing section 120. The RAM may include a nonvolatile RAM. The nonvolatile memory preferably secures storage regions of various pieces of data.

The operation section 150 is formed of, for example, a button, a key, a microphone, and a touch panel so as to have a voice recognition function (using the microphone (not illustrated)) and an action detection function (using the acceleration sensor 113 or the like), and performs a process of converting an instruction from the user into an appropriate signal which is then sent to the processing section 120.

The clocking section 160 is formed of, for example, a real time clock (RTC) IC or the like, and generates time data such as year, month, day, hour, minute, and second, and sends the data to the processing section 120.

The display section 170 is formed of, for example, a liquid crystal display (LCD), an organic electroluminescence (EL) display, an electrophoretic display (EPD), or a touch panel display, and displays various images in response to instructions from the processing section 120.

The sound output section 180 is formed of, for example, a speaker, a buzzer, or a vibrator, and generates various sounds (or vibration) in response to instructions from the processing section 120.

The communication section 190 performs a variety of control for establishing data communication between the electronic apparatus 1 and the information terminal 2 (a smart phone or the like). The communication section 190 is configured to include a transceiver based on a short-range wireless communication standard such as Bluetooth (registered trademark) (including Bluetooth Low Energy (BTLE)), Wi-Fi (registered trademark) (Wireless Fidelity), Zigbee (registered trademark), near field communication (NFC), or ANT+(registered trademark).

### 1-2-1. Details of Processing Section of Electronic Apparatus

As illustrated in FIG. 2, the processing section 120 of the electronic apparatus 1 functions as a number-of-steps calculation unit 121, a motion time calculation unit 122, a calorie calculation unit 123, a sleeping time calculation unit 124, a mental balance calculation unit 125, a movement distance calculation unit 126, an achievement level calculation unit 127, a distance calculation unit 121′, a time calculation unit 122′, a pace calculation unit 123′, a heartbeat calculation unit 124′, and the like, as appropriate. Above all, the number-of-steps calculation unit 121, the motion time calculation unit 122, the calorie calculation unit 123, the sleeping time calculation unit 124, the mental balance calculation unit 125, the movement distance calculation unit 126, and the achievement level calculation unit 127 correspond to the life logger function of the processing section 120, and the distance calculation unit 121′, the time calculation unit 122′, the pace calculation unit 123′, and the heartbeat calculation unit 124′ correspond to the performance monitor function of the processing section 120.

The number-of-steps calculation unit 121 counts the number of steps of the user on the basis of, for example, an output from the acceleration sensor 113, an output from the angular velocity sensor 114, and user physical data (user physical data written in the storage section 130 in advance). At least one of the acceleration sensor 113 and the GPS sensor 110 may be used to count the number of steps. The number-of-steps calculation unit 121 may count the number of steps when a heart rate is included in a predetermined heart rate zone. Whether or not the heart rate is included in the predetermined heartbeat zone may be determined on the basis of, for example, an output to the pulse sensor 115 from the processing section 120. The heartbeat zone is set on the basis of the user physical data, and includes, for example, a zone suitable for fat combustion, and a zone suitable for motion performance improvement. Computation of the heartbeat zone is well known, and thus detailed description thereof will be omitted. The heartbeat zone may be determined on the basis of both a heart rate and accelerations. The number-of-steps calculation unit 121 calculates the number of steps for each date and the number of steps for a week including a day to which the present time belongs, and writes the number of steps to the storage section 130.

The motion time calculation unit 122 calculates a motion time of the user on the basis of, for example, an output from the acceleration sensor 113 and an output from the angular velocity sensor 114. This calculation may be performed by using an output from the GPS sensor 110. The motion time calculation unit 122 may calculate a motion time when the heart rate is included in a predetermined heartbeat zone. The processing section 120 may determine whether or not a heart rate is included in the predetermined heartbeat zone on the basis of, for example, an output from the pulse sensor 115. The motion time calculation unit 122 calculates a motion time for each date and motion times for a week including a day to which the present time belongs, and writes the motion times to the storage section 130.

The calorie calculation unit 123 calculates calorie consumption on the basis of, for example, the user physical data and an output from the pulse sensor 115. The calorie calculation unit 123 sets a basal metabolic rate of the user on the basis of the age, the sex, and the like included in the user physical data, and calculates calorie consumption on the basis of the basal metabolic rate. Calculation of the calorie consumption is performed according to a well-known method such as a method in which calorie consumption is calculated by using information regarding a pulse rate, age, and sex, or a method in which a basal metabolic rate is obtained by using information regarding a weight or a height. The calorie calculation unit 123 may compute a total value of calorie intake on the basis of meal information of the user so as to calculate calorie balance. The meal information of the user may be manually input by the user via, for example, the operation section 150. The calorie calculation unit 123 calculates calorie consumption for each date and calorie consumption for a week including a day to which the present time belongs, and writes the calorie consumption to the storage section 130.

The sleeping time calculation unit 124 calculates a sleeping time of the user on the basis of, for example, an output from the acceleration sensor 113, an output from the angular velocity sensor 114, and an output from the pulse sensor 115. The sleeping time calculation unit 124 determines whether or not the user is sleeping on the basis of an output from the acceleration sensor 113 and an output from the angular velocity sensor 114. The sleeping time calculation unit 124 may determine whether the user is in a light sleeping state or a deep sleeping state on the basis of an output from the pulse sensor 115 during sleeping, and may calculate a light sleeping time and a deep sleeping time. The sleeping time calculation unit 124 calculates a sleeping time for each date and sleeping times for a week including a day to which the present time belongs, and writes the sleeping times to the storage section 130.

The mental balance calculation unit 125 calculates, for example, a ratio (mental balance) between time (excitation time) in a state in which the user is excited during non-motion and time (relaxing time) in a state in which the user relaxes during non-motion on the basis of, for example, an output from the acceleration sensor 113, an output from the angular velocity sensor 114, an output from the GPS sensor 110, and an output from the pulse sensor 115. A calculated excitation time may be an excitation time during motion, and a calculated relaxing time may be a relaxing time during motion. In a case where a change in an output from the acceleration sensor 113 is not included in a motion acceleration range (a range of a change in acceleration divided into motions), and a measured pulse rate which is measured by the pulse sensor 115 is included in a motion pulse rate range (a range of a change in acceleration divided into motions), the mental balance calculation unit 125 determines that the user is in an excitation state (sympathetic nerve active state) not due to motion. In a case where a change in an output from the acceleration sensor 113 is not included in a motion acceleration range (a range of a change in acceleration divided into motions), and a measured pulse rate which is measured by the pulse sensor 115 is not included in a motion pulse rate range (a range of a change in acceleration divided into motions), the mental balance calculation unit 125 determines that the user is in a relaxing state (parasympathetic nerve active state). The mental balance calculation unit 125 may calculate an index HF/LF (HF: high frequency, and LF: low frequency) indicating active states of a sympathetic nerve and a parasympathetic nerve on the basis of a pulse wave measured by the pulse sensor 115, so as to determine an excitation state or a relaxing state. The mental balance calculation unit 125 may calculate a mental balance for each time, a mental balance for each date, and mental balances for a week including a day to which the present time belongs, and may write the mental balances to the storage section 130. A method of calculating a mental balance using the index HF/LF will be described later. A mental balance based on the index HF/LF is differentiated from a mental balance based on time in an excitation state and time in a relaxing state, and may thus be said to be “stress”.

The movement distance calculation unit 126 calculates a movement distance of the user on the basis of, for example, an output from the GPS sensor 110, an output from the geomagnetic sensor 111, an output from the atmospheric pressure sensor 112, an output from the acceleration sensor 113, and an output from the angular velocity sensor 114. The movement distance calculation unit 126 can calculate a movement distance on the basis of only an output from the GPS sensor 110, but may not receive a GPS signal depending on an environment in which the electronic apparatus 1 is present. Therefore, for example, a movement distance calculated on the basis of an output from the GPS sensor 110 is corrected as appropriate on the basis of at least one of an output from the geomagnetic sensor 111, an output from the atmospheric pressure sensor 112, an output from the acceleration sensor 113, and an output from the angular velocity sensor 114, or a movement distance in a period in which a GPS signal cannot be received is estimated. The movement distance calculation unit 126 calculates a movement distance for each date and movement distances for a week including a day to which the present time belongs, and writes the movement distances to the storage section 130.

The achievement level calculation unit 127 calculates at least one of a ratio (an achievement level of the number of steps) of a calculated number of steps to the target number of steps, a ratio (an achievement level of a motion time) of a calculated motion time to the target motion time, a ratio (an achievement level of calorie consumption) of calculated calorie consumption to the target calorie consumption, a ratio (an achievement level of a sleeping time) of a measured sleeping time to the target sleeping time, a ratio (an achievement level of a mental balance) of a measured mental balance to the target mental balance, and a ratio (an achievement level of a movement distance) of a measured movement distance to the target movement distance, on the basis of the number of steps (calculated number of steps), a motion time (calculated motion time), calorie consumption (calculated calorie consumption), a sleeping time (calculated sleeping time), a mental balance (calculated mental balance), and a movement distance (calculated movement distance) which are calculated, and the target number of steps of the user, the target motion time, the target calorie consumption, the target sleeping time, the target mental balance, and the target movement distance. The achievement level calculation unit 127 may calculate achievement levels for each date and achievement levels for a week including a day to which the present time belongs. The achievement level calculation unit 127 writes the calculated achievement levels to the storage section 130.

In a case where a “time lap section” is set as a lap section of a course along which the user moves, the distance calculation unit 121′ calculates a movement distance of the user in a period from the start time to the end time of the lap section as a lap distance of the lap section on the basis of, for example, an output from the clocking section 160 and an output from the GPS sensor 110. A cumulative traveling distance and the lap distance calculated by the distance calculation unit 121′ are written to the storage section 130. The distance calculation unit 121′ may improve distance calculation accuracy by using at least one of an output from the acceleration sensor 113, an output from the angular velocity sensor 114, the user physical data, an output from the geomagnetic sensor 111, and an output from the atmospheric pressure sensor 112.

The time calculation unit 122′ calculates an elapsed time from the start time of a course to the present time as a split time of the user on the basis of, for example, an output from the clocking section 160. In a case where a “distance lap section” is set as a lap section, the time calculation unit 122′ calculates a movement time of the user in a path from a start point of the lap section to an end point as a lap time of the lap section on the basis of, for example, an output from the clocking section 160 and an output from the GPS sensor 110. The split time and the lap time calculated by the time calculation unit 122′ are written to the storage section 130. The time calculation unit 122′ may improve time calculation accuracy by using at least one of an output from the acceleration sensor 113, an output from the angular velocity sensor 114, the user physical data, an output from the geomagnetic sensor 111, and an output from the atmospheric pressure sensor 112.

The pace calculation unit 123′ calculates an average traveling speed of the user from a start point of a course to the present point as an average pace of the user on the basis of, for example, an output from the clocking section 160 and an output from the GPS sensor 110. In a case where a “time lap section” is set as a lap section, the pace calculation unit 123′ calculates an average traveling speed of the user in a period from the start time to the end time of the lap section as a lap pace of the lap section on the basis of, for example, an output from the clocking section 160 and an output from the GPS sensor 110. In a case where a “distance lap section” is set as a lap section, the pace calculation unit 123′ calculates an average traveling speed of the user in a path from a start point of the lap section to an end point as a lap pace on the basis of, for example, an output from the clocking section 160 and an output from the GPS sensor 110.

The heartbeat calculation unit 124′ calculates an average heart rate of the user per unit time from the start time of a course to the present time on the basis of, for example, an output from the clocking section 160 and an output from the pulse sensor 115. In a case where a “time lap section” is set as a lap section, the heartbeat calculation unit 124′ calculates an average heart rate of the user in a period from the start time to the end time of the lap section as a lap heart rate of the user on the basis of, for example, an output from the clocking section 160 and an output from the pulse sensor 115. In a case where a “distance lap section” is set as a lap section, the heartbeat calculation unit 124′ calculates an average heart rate of the user in a path from a start point of the lap section to an end point as a lap heart rate on the basis of, for example, an output from the clocking section 160 and an output from the pulse sensor 115.

### 1-3. Configuration of Information Terminal

The information terminal 2 is an information terminal such as a smart phone, a tablet PC, or a desktop PC which can be connected to the network 3 such as the Internet.

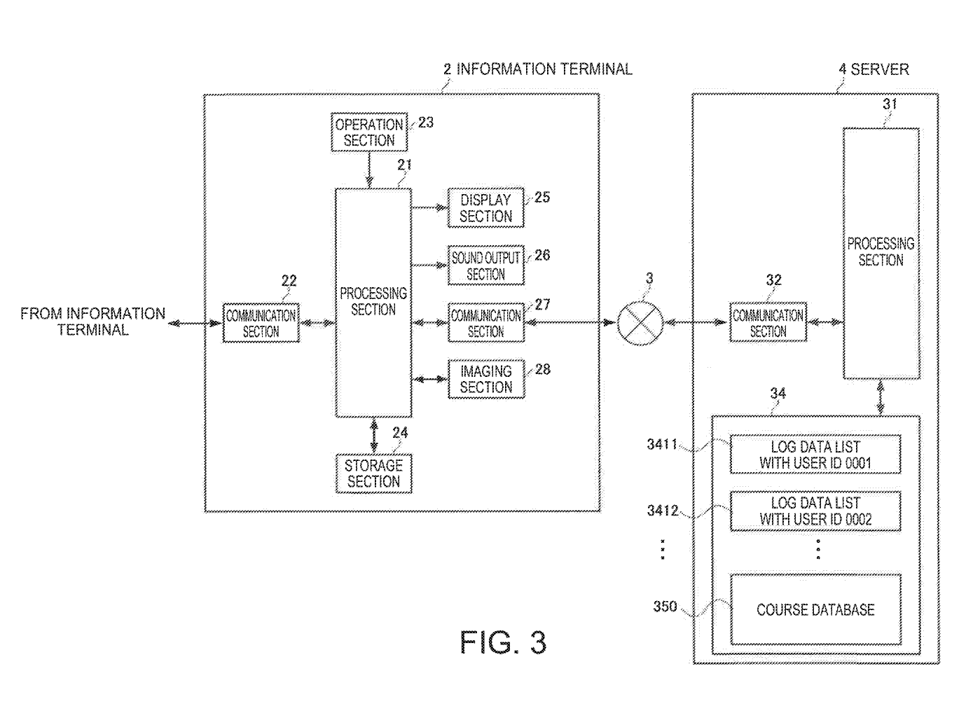

As illustrated in FIG. 3, the information terminal 2 is configured to include a processing section 21, a communication section 22, an operation section 23, a storage section 24, a display section 25, a sound output section 26, a communication section 27, and an imaging section 28. However, the information terminal 2 may have a configuration in which some of the constituent elements are deleted or changed as appropriate, or may have a configuration in which other constituent elements are added thereto.

The processing section 21 (an example of an acquisition section) is formed of, for example, a central processing unit (CPU), a digital signal processor (DSP), and an application specific integrated circuit (ASIC). The processing section 21 performs various processes according to a program (an example of an information output program) stored in the storage section 24, and various commands which are input by the user via the operation section 23. The processes in the processing section 21 include, for example, data processing on data which is generated by the electronic apparatus 1, display processing for displaying an image on the display section 25, sound output processing for outputting sounds from the sound output section 26, and image processing on an image acquired by the imaging section 28. The processing section 21 may be formed of a single processor, and may be formed of a plurality of processors.

The communication section 22 performs a process of receiving data (measured data) or the like transmitted from the electronic apparatus 1 in a predetermined format and sending the data to the processing section 21, a process of transmitting a control command from the processing section 21 to the electronic apparatus 1, or the like.

The operation section 23 performs a process of acquiring data corresponding to the user's operation, and sending the data to the processing section 21. The operation section 23 may be, for example, a touch panel display, a button, a key, and a microphone.

The storage section 24 is formed of, for example, various IC memories such as a ROM, a flash ROM, and a RAM, or a recording medium such as a hard disk or a memory card. The storage section 24 stores programs for the processing section 21 performing various computation processes or control processes, various programs (examples of information output programs) or data for realizing application functions. The storage section 24 is used as a work region of the processing section 21, and temporarily stores data which is input from the operation section 23, results of calculation executed by the processing section 21 according to various programs, and the like. The storage section 24 may store data which is required to be preserved for a long period of time among data items generated through processing in the processing section 21. The RAM may include a nonvolatile RAM. The nonvolatile memory preferably secures storage regions of various pieces of data.

The display section 25 displays a processing result in the processing section 21 as text, a graph, a table, animation, and other images. The display section 25 may be, for example, a cathode ray tube (CRT), a liquid crystal display (LCD), a touch panel display, and a head mounted display (HMD). A single touch panel display may realize functions of the operation section 23 and the display section 25.

The sound output section 26 outputs a processing result in the processing section 21 as a sound such as a voice or a buzzer sound. The sound output section 26 may be, for example, a speaker or a buzzer.

The communication section 27 performs data communication with a communication section of the server 4 via the network 3. For example, the communication section 27 performs a process of receiving data from the processing section 21 and transmitting the data to the communication section of the server 4 in a predetermined format. For example, the communication section 27 performs a process of receiving information required to display a screen from the communication section of the server 4 and sending the information to the processing section 21, or a process of receiving various pieces of information from the processing section 21 and transmitting the information to the communication section of the server 4.

The imaging section 28 is a camera including a lens, a color imaging element, a focus adjustment mechanism, and the like, and generates a picture of a field generated by the lens as an image with the imaging element. Data (image data) regarding the image acquired by the imaging element is sent to the processing section 21 so as to be preserved in the storage section 24 or displayed on the display section 25.

The processing section 21 performs a process of transmitting a control command to the electronic apparatus 1 via the communication section 22, or various computation processes on data which is received from the electronic apparatus 1 via the communication section 22, according to various programs. The processing section 21 performs a process of reading data from the storage section 24, and transmitting the data to the server 4 via the communication section 27 in a predetermined format, according to various programs. The processing section 21 performs a process of transmitting various pieces of information to the server 4 via the communication section 27, and displaying various screens on the basis of information received from the server 4, according to various programs. The processing section 21 performs other various control processes. For example, the processing section 21 performs a process of displaying images (images, moving images, text, symbols, and the like) on the display section 25 on the basis of at least some of the information received by the communication section 27, the information received by the communication section 22, and information stored in the storage section 24. A vibration mechanism may be provided in the information terminal 2 or the electronic apparatus 1, and various pieces of information may be converted into vibration pieces of information by the vibration mechanism so as to be presented to the user.

### 1-4. Configuration of Server

As illustrated in FIG. 3, the server 4 is configured to include a processing section 31, a communication section 32, and a storage section 34. However, the server 4 may have a configuration in which some of the constituent elements are deleted or changed as appropriate, or may have a configuration in which other constituent elements are added thereto.

The storage section 34 is constituted of, for example, various IC memories such as a ROM, a flash ROM, and a RAM, or a recording medium such as a hard disk or a memory card. The storage section 34 stores a program for the processing section 31 performing various calculation processes or a control process, or various programs (examples of information output programs) or data for realizing application functions. The RAM may include a nonvolatile RAM. The nonvolatile memory preferably secures storage regions of various pieces of data.

The storage section 34 is used as a work region of the processing section 31, and temporarily stores results of calculation executed by the processing section 31 according to various programs, and the like. The storage section 34 may store data which is required to be preserved for a long period of time among pieces of data generated through processing of the processing section 31. Various pieces of information stored in the storage section 34 will be described later.

The communication section 32 performs data communication with the communication section 27 of the information terminal 2 via the network 3. For example, the communication section 32 performs a process of receiving data from the communication section 27 of the information terminal 2, and sending the data to the processing section 31. For example, the communication section 32 performs a process of transmitting information required to display a screen to the communication section 27 of the information terminal 2 in a predetermined format, or a process of receiving information from the communication section 27 of the information terminal 2 and sending the information to the processing section 31.

The processing section 31 performs a process of receiving data from the information terminal 2 via the communication section 32 and storing the data in the storage section 34, according to various programs. The processing section 31 performs a process of receiving various pieces of information from the information terminal 2 via the communication section 32, and transmitting information required to display various screens to the information terminal 2, according to various programs. The processing section 31 performs other various control processes. The processing section 31 may be formed of a single processor, and may be formed of a plurality of processors.

### 1-5. Life Logger Function of Electronic Apparatus

Hereinafter, a description will be made focusing on the life logger function of the electronic apparatus.

In pre-preparation, the user displays a menu screen on the display section 170 of the electronic apparatus 1, and inputs data (user physical data) regarding the user's body, such as a height, a weight, age, sex, and a body fat percentage. The user causes the electronic apparatus 1 to start activity amount measurement, and inputs a target (a target regarding the life) for each item, on the menu screen.

Thereafter, the user lives, for example, for a week in a state of mounting the electronic apparatus 1 on the arm. The electronic apparatus 1 operates as a life logger, and repeatedly records log data (the log data mentioned here is data regarding the life, and is, for example, the number of steps, a motion time, calorie, a sleeping time, a mental balance, a movement distance, and an achievement level) in the storage section 130. Consequently, the log data regarding the life of the user is accumulated in the storage section 130.

Next, the user may connect the electronic apparatus 1 to the information terminal 2 such as a smart phone, a tablet PC, a desktop PC via short-range radio communication or the like, so as to transmit the log data (here, the log data regarding the life), user target data, and user physical data accumulated in the storage section 130 of the electronic apparatus 1 to the information terminal 2.

FIG. 9 illustrates an example of the log data regarding the life. The log data regarding the life is at least one of a movement distance, a motion time, the number of steps, a walking pace, a walking pitch, a stride, the number of fast steps, the number of running steps, the number of increasing stories (“five stories”, “two stories”, or the like), the number of increasing stairs (“100 stairs”, “200 stairs”, or the like), a heart rate, a sleeping time, stress (a balance between an excitation state and a relaxing state), oxygen intake, an amount of perspiration, water intake (which is manually input by the user), calorie consumption, calorie intake (which is manually input by the user), calories balance, a weight (which is input through communication with a weight meter or is manually input by the user), a waist size (which is manually input by the user), balance between an excitation time and a relaxing time (mental balance), a heart rate, a target achievement level, an ultraviolet quantity, SpO₂ (an estimated value of arterial blood oxygen saturation), a sleep state (proportions or scores of a deep sleep, a light sleeps, a good sleep, and a bad sleep), and the like. Log data regarding motion and log data regarding the life may overlap each other in some parameters (items). This is because a parameter such as a heartbeat is related to both motion and the life. Values, units, periods, and the like of overlapping parameters may be the same as or different from each other in a parameter regarding motion and a parameter regarding the life.

The user physical data may be input not on the electronic apparatus 1 but on the information terminal 2. In this case, the user physical data is transmitted from the information terminal 2 to the electronic apparatus 1 as necessary.

The user may connect the information terminal 2 to the server 4 via the network 3 such as the Internet so as to upload the log data (log data regarding the life), the user target data, and the user physical data to the server 4 and to store the data in the storage section 34 of the server 4. The user physical data of the user is stored in a log data list of the user along with the log data of the user. Hereinafter, unless otherwise mentioned, the user physical data is assumed to be included in the log data list of the storage section 34.

The user can check the log data thereof (log data regarding the life) on the information terminal 2 by connecting the information terminal 2 to the server 4 via the network 3 such as the Internet at a desired timing. In this case, the user may be provided with various pieces of additional information (application software programs, map data, and the like) from the server 4.

It is assumed that the user connects the information terminal 2 to the server 4 via the network 3 such as the Internet in advance, and transmits registration information such as the user physical data of the user to the server 4 so that user registration in the server 4 is completed. Due to the user registration, the server 4 assigns a user ID (identification information) to the user. After the registration, the user can be provided with a service of storing log data (log data regarding the life) and the above-described additional information (application software programs, map data, and the like) from the server 4.

In the system of the present embodiment, the electronic apparatus 1 acquires the number of steps, a motion time, calorie, a sleeping time, a mental balance, a movement distance, an achievement level, and the like as the log data regarding the life of the user, and the log data is transmitted to the information terminal 2, and is uploaded to the server 4 from the information terminal 2, but log data transmitted to the information terminal 2 or log data uploaded to the server 4 may include other information regarding the user's life, and may include sensing data (sensor output) for calculating information regarding the user's life or data obtained in a calculation process. In other words, a function of generating information regarding the life on the basis of sensing data (sensor output) may be installed in the electronic apparatus 1, may be installed in the information terminal 2, and may be installed in the server 4. In the system of the present embodiment, it is assumed that time information and position information are added to individual log data which is transmitted or uploaded. The time information added to certain log data is information indicating a detection time point of sensing data (sensor output) which is a generation source of the log data, and the position information added to the log data is information indicating a position of the electronic apparatus 1 at the detection time point.

### 1-6. Performance Monitor Function of Electronic Apparatus

Hereinafter, a description will be made focusing on the performance monitor function of the electronic apparatus.

In pre-preparation, the user displays a menu screen on the display section 170 of the electronic apparatus 1, and inputs data (user physical data) regarding the user's body, such as a height, a weight, age, sex, and a body fat percentage. The user performs settings regarding a lap section on the menu screen, and returns the electronic apparatus 1 to a time display mode. The user may input target data (a target regarding motion) along with the physical data.

Thereafter, the user performs, for example, training (also referred to as motion which is an example of physical activity of the user) accompanied by movement in a course in a state of mounting the electronic apparatus 1 on the arm. The electronic apparatus 1 operates as a performance monitor, and repeatedly records log data (the log data mentioned here is data regarding motion, and is, for example, a movement distance in each lap section, time in each lap section, time in each lap section, a pace in each lap section, and a heart rate in each lap section) in the storage section 130. Consequently, the log data regarding motion of the user is accumulated in the storage section 130. A training course (including a course in which training will be performed in the future and a course in which training was performed in the past) may also be referred to as an activity route, a movement route for activity, a route for activity, and the like, and the “course” may be said to be a “geographic route”.

Next, the user may connect the electronic apparatus 1 to the information terminal 2 such as a smart phone, a tablet personal computer (PC), a desktop PC via short-range radio communication or the like, so as to transmit the log data (here, the log data regarding motion), user target data, and user physical data accumulated in the storage section 130 of the electronic apparatus 1 to the information terminal 2. FIG. 9 illustrates an example of the log data regarding motion. The log data regarding motion is at least one of a motion distance (a movement distance or a cumulative movement distance), a motion time, a motion time in a predetermined heartbeat zone, the number of steps, the number of lap steps, a pace, a pitch, a stride, the split time, the lap time, cumulative increasing altitude, cumulative decreasing altitude, an elevation (average altitude of a motion location), gradient, the number of times of training (the number of times of running, the maximum number of times of running, an average number of times of running, or the like), a target achievement level, an attitude (running attitude, left/right difference, foot contact time, a directly-below landing ratio, propulsion efficiency, slow turnover of the legs, a landing brake quantity, landing impact), a heart rate, calorie consumption, oxygen intake, VO₂max (max oxygen intake), an amount of perspiration, water intake, an expected motion distance under a predetermined condition (a movement distance or an expected cumulative distance), the time until reaching a predetermined heartbeat zone, heartbeat recovery time, an expected pace under a predetermined condition, an expected pitch under a predetermined condition, an expected stride under a predetermined condition, an expected time under a predetermined condition (a lap time or a split time), expected calorie consumption under a predetermined condition, an automatically generated target, an ultraviolet quantity, SpO₂ (an estimated value of arterial blood oxygen saturation), an event, user performance data for each event, and the like.

Log data regarding motion and log data regarding the life may overlap each other in some parameters (items). This is because a parameter such as a heartbeat is related to both motion and the life. Values, units, periods, and the like of overlapping parameters may be the same as or different from each other in a parameter regarding motion and a parameter regarding the life.

The user physical data may be input not on the electronic apparatus 1 but on the information terminal 2. In this case, the user physical data is transmitted from the information terminal 2 to the electronic apparatus 1 as necessary.

The user may connect the information terminal 2 to the server 4 via the network 3 such as the Internet so as to upload the log data (log data regarding motion), the user target data, and the user physical data to the server 4 and to store the data in the storage section 34 of the server 4.

The user can check the log data thereof (log data regarding motion) on the information terminal 2 by connecting the information terminal 2 to the server 4 via the network 3 such as the Internet at a desired timing. In this case, the user may be provided with various pieces of additional information (application software programs, map data, and the like) from the server 4.

It is assumed that the user connects the information terminal 2 to the server 4 via the network such as the Internet in advance, and transmits registration information such as the user physical data of the user to the server 4 so that user registration in the server 4 is completed. Due to the user registration, the server 4 assigns a user ID (identification information) to the user. After the registration, the user can be provided with a service of storing log data (log data regarding motion) and the above-described additional information (application software programs, map data, and the like) from the server 4.

In the system of the present embodiment, the electronic apparatus 1 acquires a movement distance in each lap section, time in each lap section, a pace in each lap section, a heart rate in each lap section, and the like as log data regarding motion of the user, and the log data is transmitted to the information terminal 2, and is uploaded to the server 4 from the information terminal 2, but log data transmitted to the information terminal 2 or log data uploaded to the server 4 may include other information regarding the user's motion, and may include sensing data (sensor output) for calculating information regarding the user's motion or data obtained in a calculation process. In other words, a function of generating information regarding motion on the basis of sensing data (sensor output) may be installed in the electronic apparatus 1, may be installed in the information terminal 2, and may be installed in the server 4. In the system of the present embodiment, it is assumed that time information and position information are added to individual log data which is transmitted or uploaded. The time information added to certain log data is information indicating a detection time point of sensing data (sensor output) which is a generation source of the log data, and the position information added to the log data is information indicating a position of the electronic apparatus 1 at the detection time point.

### 1-7. Management of Log Data in Server

FIG. 3 is referred to again. The server 4 records and manages log data (the log data regarding the life and the log data regarding motion) uploaded from users via the information terminal 2 for each user. Hereinafter, at least one of the log data regarding the life and the log data regarding motion will be referred to as “log data” as appropriate. The log data is an example of body condition information regarding a user's body condition, and is an example of information based on data from a sensor. The data from a sensor may include at least one of data detected by at least one sensor, data obtained by processing the data detected by at least one sensor, and data obtained by converting a format or the like of the data detected by at least one sensor. The information based on the data from a sensor may include at least one of, in principle, information generated by using the data detected by at least one sensor, data generated by using the data detected by at least one sensor, data obtained by processing the data detected by at least one sensor, or the data detected by at least one sensor and data other than the data detected by at least one sensor, or data obtained by converting a format or the like of the data detected by at least one sensor. The term “data” is the more specific concept of the term “information”, and is assumed to indicate information in a state of being able to be processed by a computer.

As illustrated in FIG. 3, the storage section 34 of the server 4 stores a plurality of (N) log data lists 3411, 3412, . . . . The log data lists 3411, 3412, . . . are log data lists which are individually uploaded from a plurality of users registered in the server 4.

For example, log data (log data regarding the life and log data regarding motion) of a user assigned with a user ID “0001” is accumulated in the log data list 3411.

For example, log data (log data regarding the life and log data regarding motion) of a user assigned with a user ID “0002” is accumulated in the log data list 3412.

If the processing section 31 of the server 4 receives an upload request, log data (log data regarding the life and log data regarding motion), and a user ID via the communication section 27 of the information terminal 2 used by a user for which registration is completed in advance, the network 3, and the communication section 32 of the server 4, the processing section 31 adds the received log data in a log data list corresponding to the user ID among the log data lists 3411, 3412, . . . stored in the storage section 34. In a case where course data (which will be described later) is included in the received log data, the processing section 31 of the server 4 registers the course data in a database 350 of the storage section 34. Details of the database 350 will be described later.

If the processing section 31 of the server 4 receives a download request, log data (log data regarding the life and log data regarding motion), and a user ID via the communication section 27 of the information terminal 2 used by a user for which registration is completed in advance, the network 3, and the communication section 32 of the server 4, the processing section 31 reads a part or the whole of a log data list corresponding to the user ID among the log data lists 3411, 3412, . . . stored in the storage section 34, and transmits the log data list to the information terminal 2 via the communication section 32, the network 3, and the communication section 27.

### 1-8. Overview of Course Recommendation Process in Server

The user operates the information terminal 2 before motion (training) so as to access the server 4, and transmits a request for generation of a recommended course and a user ID to the server 4.

In this case, the processing section 21 of the information terminal 2 acquires information (described below) required to generate a recommended course, and transmits the information to the server 4 along with the request for generation of a recommended course and the user ID. Transmission of the information from the processing section 21 of the information terminal 2 to the server 4 is performed via the communication section 27, the network 3, and the communication section 32 of the server 4, and transmission of the information from the processing section 31 of the server 4 to the information terminal 2 is performed via the communication section 32, the network 3, and the communication section 27 (the same applies hereinafter).

Here, the information required to generate a recommended course is, for example, (i) a position of the user at the present time, (ii) log data regarding the life of the user in a predetermined period such as last 24 hours (an example of the time before activity is started), and (iii) log data regarding motion of the user in a predetermined period such as last one month (an example of the time before activity is started).

A position of the user may be generated by the processing section 120 of the electronic apparatus 1 or the processing section 21 of the information terminal 2 on the basis of positioning data output from the GPS sensor 110 of the electronic apparatus 1. The positioning data or the position of the user is transmitted from the electronic apparatus 1 to the information terminal 2 in a predetermined format at an appropriate timing via the communication section 190 of the electronic apparatus 1 and the communication section 22 of the information terminal 2. In a case where a GPS sensor (not illustrated) is mounted on the information terminal 2, the processing section 21 of the information terminal 2 may generate a position of the user on the basis of an output from the GPS sensor (not illustrated). In a case where log data regarding the life in a predetermined period and the latest log data regarding motion in a predetermined period have been uploaded from the information terminal 2 to the server 4, the log data is not required to be transmitted from the information terminal 2 to the server 4 again.

The processing section 31 of the server 4 refers to the log data list corresponding to the user ID of the user, and acquires body condition information (fatigue degree) regarding a body condition of the user before training is started on the basis of the log data regarding the life of the user and the log data regarding motion of the user. The processing section 31 determines a training course suitable for the user and an event (an example of the type of training) of training (an example of activity) suitable for the user at the present time on the basis of the body condition information (fatigue degree). Hereinafter, the determined course (an example of a recommended route) will be referred to as a “recommended course”, and the determined event will be referred to as a “recommended event” or “recommended training event”.

For example, the processing section 31 of the server 4 performs a course recommendation process which will be described later, and determines a recommended course and a recommended event for the user on the basis of a position of the user at the present time, weather information (provided from a weather server) in an area to which the position belongs, the latest log data (stored in the log data list corresponding to the user ID) of the user, and the database 350. The processing section 31 of the server 4 transmits the information regarding the recommended course and the recommended event to the information terminal 2 in a predetermined format via the communication section 32, the network 3, and the communication section 27. The display section 25 of the information terminal 2 displays the received information in an appropriate format. In other words, the processing section 31 of the server 4 presents the recommended course and the recommended event to the user via the information terminal 2. The number of recommended courses generated by the server 4 may be one, but may be two or more.

Here, the weather information used for the course recommendation process is, for example, weather information which is temporarily stored in the storage section 34 of the server 4, and is the latest weather information which is appropriately provided from a weather server (not illustrated) connected to the network 3. The processing section 31 of the server 4 is assumed to receive weather information of a necessary area from the weather server as necessary or periodically. The “necessary area” mentioned here is an area to which a position of the user as a source of issuing a request for generation of a recommended course belongs.

The processing section 31 of the server 4 may present a target of training to the user along with the recommended course and the recommended event. The target of training is a target of performance of the user in the process of training, and is, for example, a target of a movement speed, a target of a movement time, a target of a heart rate, or the like in each section of a recommended course. The target is preferably determined on the basis of a body condition (physical fatigue degree and mental fatigue degree) of the user at the present time, physical or mental tendency (type) of the user estimated from log data of the user, or user physical data (the type of physique or the age) of the user. A “section” may not necessarily match a “lap section” (the same applies hereinafter).

### 1-9. Navigation Function of Electronic Apparatus

The user operates the information terminal 2 before training, so as to transmit information regarding a recommended course and a recommended event from the information terminal 2 to the electronic apparatus 1. Transmission of the information from the information terminal 2 to the electronic apparatus 1 is performed via the communication section 22 of the information terminal 2 and the communication section 190 of the electronic apparatus 1, and transmission of the information from the electronic apparatus 1 to the information terminal 2 is performed via the communication section 190 of the electronic apparatus 1 and the communication section 22 of the information terminal 2 in a predetermined format (the same applies hereinafter). The recommended course is an example of a recommended route.

The user operates the operation section 150 of the electronic apparatus 1 so as to select a course and an event in which the user want to perform training from among two or more recommended courses, and starts training according to the selected course and event. Information regarding the selected course and event is used for a navigation function (which will be described later) during training.

Here, the user may manually input the course and the event selected by the user to the electronic apparatus 1, and may omit manual inputting. However, in a case where inputting is omitted, in principle, it is assumed that, when training is started, the user operates the operation section 150 of the electronic apparatus 1 so as to input a notification of starting of the training to the electronic apparatus 1, and, when the training is completed, the user operates the operation section 150 of the electronic apparatus 1 so as to input a notification of completion of the training to the electronic apparatus 1.

In a case where inputting by the user is omitted, a course and an event in which the user has actually performed training may be input by the user after the training is started (during training) or the training is completed, or may be determined by the electronic apparatus 1. The determination may be performed by the information terminal 2. In this case, log data during training is assumed to be sequentially transmitted to the information terminal 2. The determination may be performed by the server 4. In this case, it is assumed that log data is transmitted from the electronic apparatus 1 to the server 4 via the information terminal 2 after the training is completed.

Determination of a course is performed, for example, on the basis of a position of the user at the start time during training (a predetermined period at initial start), and determination of an event is performed, for example, on the basis of a change in a position (including an altitude) of the user at each time point during training. Hereinafter, it is assumed that the electronic apparatus 1 determines a course at the initial start of training, and the electronic apparatus 1 sequentially determines events, for example, in the process of training.

The processing section 120 of the electronic apparatus 1 sequentially displays a course employed by the user and the present position of the user on the display section 170 during training, and thus guides the user (navigation function). During training, the processing section 120 may perform an event determination process which will be described later, and may sequentially display the determined event on the display section 170. The processing section 120 may perform a course-out determination process which will be described later, and, in a case where the present position of the user is deviated from a course (course-out), the processing section 120 may notify the user of the course-out via the display section 170 and the sound output section 180.

The processing section 120 of the electronic apparatus 1 also continuously performs recording of log data regarding the life of the user and recording of log data regarding motion of the user by developing the above-described life logger function and performance monitor function during training.

During training, the processing section 120 of the electronic apparatus 1 acquires body condition information regarding a body condition of the user on the basis of at least one of log data regarding the life and log data regarding motion, and, in a case where it is detected that the body condition of the user is not good (becomes worse) on the basis of the body condition information, the processing section 120 notifies the user of the fact.

During training, the processing section 120 of the electronic apparatus 1 detects a training event performed by the user on the basis of log data regarding motion, and, in a case where the detected training event is different from a training event which is scheduled to be performed, the processing section 120 notifies the user of the fact. The notification sent from the electronic apparatus 1 to the user is performed via the display section 170 and the sound output section 180 (the same applies hereinafter).

For example, during training, the processing section 120 of the electronic apparatus 1 may monitor heart rates of the user on the basis of outputs from the pulse sensor 115 so as to determine whether or not the heart rates are deviated from an appropriate range (appropriate zone), and may determine that a body condition of the user is not good in a case where the heart rates are deviated. The processing section 120 of the electronic apparatus 1 may calculate an appropriate zone for the user at the present time, for example, on the basis of sensing data (sensor output) which is output from one or two or more sensors other than the pulse sensor 115, the user physical data in the storage section 130, and log data of the user.

During training, the processing section 120 of the electronic apparatus 1 may modify (change) a recommended course during training according to weather information for an area to which the present position belongs, and traffic information for the area. The traffic information may be acquired by the electronic apparatus 1 via a traffic server (not illustrated), the server 4, the network 3, and the information terminal 2. The weather information may be acquired by the electronic apparatus 1 via the weather server (not illustrated), the server 4, the network 3, and the information terminal 2.

Here, the processing section 120 of the electronic apparatus 1 may reexamine a recommended course during training. The reexamination may be performed whenever the user reaches several determined waypoints (a plurality of representative positions forming a course) in the course. The processing section 120 of the electronic apparatus 1 determines the necessity of reexamination when the user comes close to a waypoint, sends a notification to the user with vibration or the like in advance in a case where it is determined that there is the necessity, and performs a course recommendation process. Reexamination is determined as being necessary if changes in situations (a change in a body condition of the user, a change in atmospheric pressure, and the like) are equal to or more than a predetermined level, and is determined as not being necessary if otherwise. The course recommendation process is the same as, for example, the course recommendation process performed by the processing section 31 of the server 4, and details of the course recommendation process will be described later.

Since a storage capacity of the storage section 130 of the electronic apparatus 1 is smaller than a storage capacity of the storage section 34 of the server 4, preferably, for example, the processing section 120 of the electronic apparatus 1 downloads course data for several courses within a restricted area around a training start point from the server 4 via the information terminal 2, and performs the course recommendation process on the basis of the downloaded course data. Specifically, for example, a search condition including position information of the electronic apparatus 1 may be transmitted to the server 4 via the information terminal 2, the server 4 may acquire course data matching the search condition from the database 350, and the acquired course data may be downloaded to the electronic apparatus 1. The processing section 120 of the electronic apparatus 1 preferably downloads weather information and traffic information for a restricted area from the server 4 via the information terminal 2, for example, when the user reaches a waypoint.

During training, the processing section 120 of the electronic apparatus 1 may perform a course-out determination process which will be described later, and, in a case where an actual movement trajectory of the user is deviated from a recommended course, or a traveling direction of the user is an opposite direction to a recommended course, the processing section 120 may notify the user of the fact.

As mentioned above, in the present system, a recommended course is determined on the basis of a body condition of the user before training, and the recommended course is updated in accordance with a body condition of the user during training. Therefore, when a body condition of the user is good (for example, when a fatigue degree is low), a course causing a high load (a course causing a heavy burden) may be set as a recommended course, and when a body condition is not good (for example, when a fatigue degree is high), a course causing a low load (a course causing a light burden) may be set as a recommended course. As mentioned above, by taking into consideration a body condition (fatigue degree) of the user, improvement of training quality, and a reduction in a risk such as injury or accident can be expected.

Course data (a position coordinate of each position on a course, a training event actually performed in the course, and the like) regarding the course along which the user has actually moved is uploaded to the server 4 via the electronic apparatus 1 and the information terminal 2 in a predetermined format if the user permits the upload. The processing section 31 of the server 4 registers the course data uploaded from the information terminal 2 in the database 350 of the storage section 34. If the server 4 collects course data from a plurality of users in the above-described way, the content of the database 350 can be enriched.

### 1-10. Display Screen

### (1) Display of Recommended Course

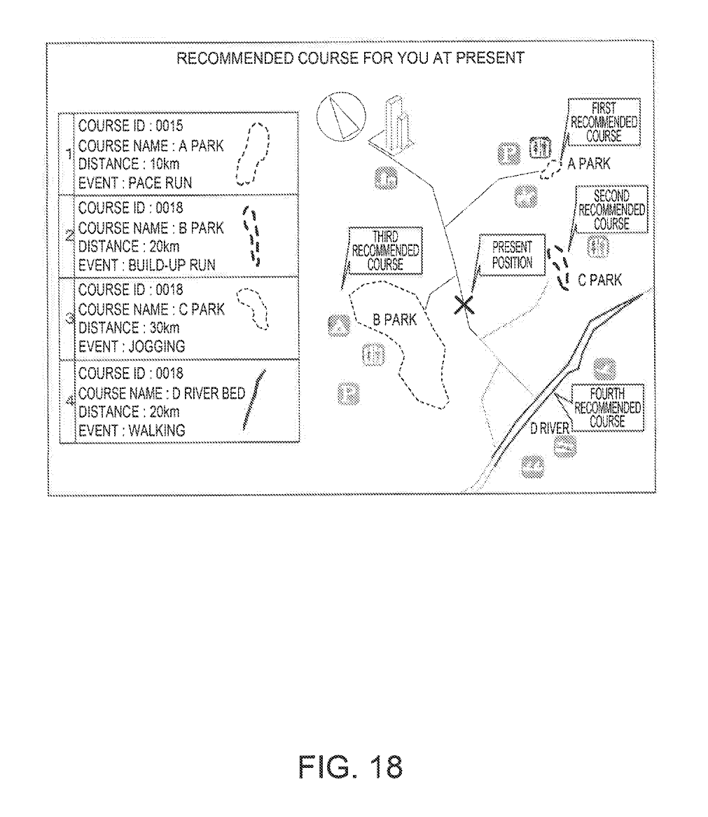

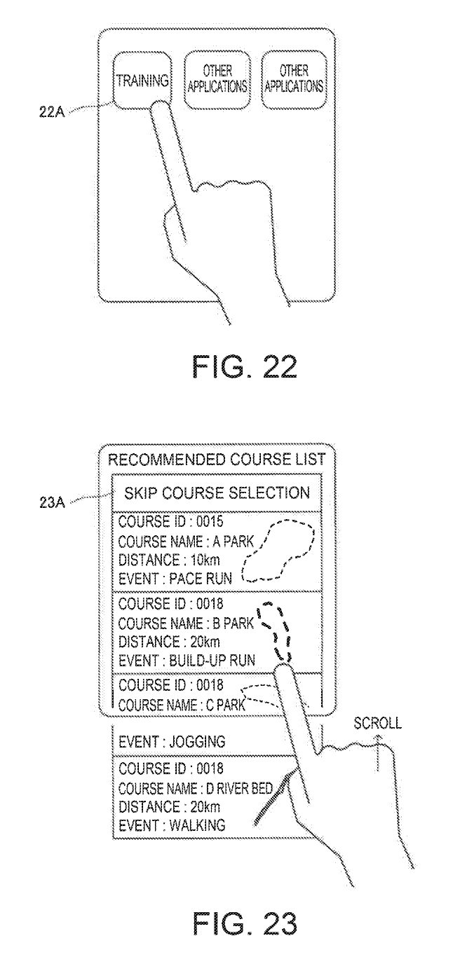

In the present system, when a recommended course is displayed on the display section 25 of the information terminal 2 or the display section 170 of the electronic apparatus 1, a map or summary information (a distance of the course, an expected required time, an elevation difference, and the like) related to the recommended course or is preferably displayed along with the recommended course (refer to FIG. 18 or the like). The sunrise time and the sunset time may be displayed, or, in a case where the present time is the evening, a remaining time until the sunset may be displayed. Weather information such as weather or temperature related to the recommended course may be displayed. In a case where there are a plurality of recommended courses, preferably, the plurality of recommended courses are scored, and are displayed in the order of scores (the score is an example of a recommendation degree, or an example of an index indicating a recommendation degree). In a case where a plurality of recommended courses are displayed on the display section 25 of the information terminal 2 or the display section 170 of the electronic apparatus 1, a user interface of the information terminal 2 or the electronic apparatus 1 is preferably configured to allow the user to select a desired course from among the plurality of recommended courses (refer to FIG. 23 or the like). Details of various display screens will be described later.

### (2) Display of Training Event

In the present system, the display section 25 of the information terminal 2 or the display section 170 of the electronic apparatus 1 may display a recommended event along with a recommended course (refer to FIG. 18 or the like). The event includes a pace run, an interval run, a build-up run, long slow distance (LSD), cross-country, jogging, walking, and the like. A recommended event displayed along with a certain recommended course is one or two or more training events suitable for the recommended course. This is because an uneven distribution, the number of signals, distance, the steepness of a curve, a state of the earth's surface (sidewalk, earth, tile, stone pavement, asphalt, gravel road, or the like), and the like differ depending on courses, and thus there is a training event suitable (or a training event not suitable) for each course. Therefore, since the user can also select a training event along with a course when selecting the course, it is possible to improve training quality more than in a case of selecting only a course. Details of various display screens will be described later.

### (3) Display of Plan and Achievement

In the present system, the display section 25 of the information terminal 2 or the display section 170 of the electronic apparatus 1 may display a course and an event selected by the user as a “plan”, and may display a course and an event which are actually employed by the user as an “achievement”, after training is completed (refer to FIG. 35 or the like). The user may use the plan and the achievement which are displayed, as a material for the user reviewing training having been performed by the user. Details of various display screens will be described later.

### 1-11. Self-Evaluation of Body Condition by User

### 1-11-1. Input Screen Using Slide Bar

The present system employs a structure of acquiring self-evaluation of a body condition performed by the user before training, and recognizing the body condition of the user in which a subjective factor is also taken into consideration.

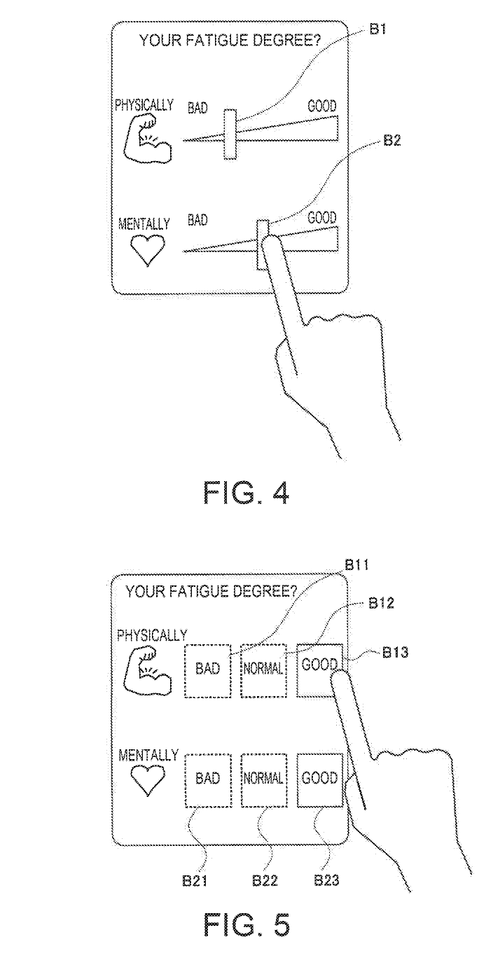

For example, the display section 25 (which is here assumed to be a touch panel display) of the information terminal 2 displays an input screen as illustrated in FIG. 4, and prompts the user to input self-evaluation. In the example illustrated in FIG. 4, a slide bar B1 for the user inputting a physical fatigue degree (an example of information regarding a physical state of the user) and a slide bar B2 for the user inputting a mental fatigue degree (an example of information regarding a mental state of the user) are displayed. The user touches the slide bars B1 and B2 on the input screen and then slides the bars horizontally, and can thus adjust slide positions of the slide bars B1 and B2.

The processing section 21 of the information terminal 2 detects slide positions of the slide bars B1 and B2 in cooperation with the touch panel display (display section 25). The processing section 21 detects a value corresponding to the slide position of the slide bar B1 as the physical fatigue degree reported by the user, and detects a value corresponding to the slide position of the slide bar B2 as the mental fatigue degree reported by the user. Consequently, the user can input the physical fatigue degree and the mental fatigue degree which are felt by the user to the information terminal 2 (these fatigue degrees are examples of body condition information based on information which is input by the user).

Thereafter, if the user taps a fixation button (not illustrated), the processing section 21 of the information terminal 2 transmits the values of the physical fatigue degree and the mental fatigue degree at the tapping time to the server 4 along with the present time. The value of the physical fatigue degree and the value of the mental fatigue degree are used for a course recommendation process in the server 4.

This is because, generally, since the way of feeling fatigue differs depending on each user, deviation may occur between a mental fatigue degree and a physical fatigue degree estimated on the basis of log data and a mental fatigue degree and a physical fatigue degree which are actually felt by the user.

The processing section 21 of the information terminal 2 may transmit information indicating a position of the user to the server 4 along with values of the fatigue degrees. The information indicating a position of the user may be acquired on the basis of positioning data output from the GPS sensor 110.

### 1-11-2. Input Screen Using Stepwise Evaluation

The display section 25 of the information terminal 2 may display an input screen as illustrated in FIG. 5 as an input screen. In the example illustrated in FIG. 5, the user may select one of three-step fatigue degrees such as “bad”, “normal”, and “good”, as a physical fatigue degree, and may select one of three-step fatigue degrees such as “bad”, “normal”, and “good”, as a mental fatigue degree.

On the input screen illustrated in FIG. 5, a select button B11 added with a text image of “bad”, a select button B12 added with a text image of “normal”, and a select button B13 added with a text image of “good” are disposed side by side as buttons for selecting a physical fatigue degree.

On the input screen illustrated in FIG. 5, a select button B21 added with a text image of “bad”, a select button B22 added with a text image of “normal”, and a select button B23 added with a text image of “good” are disposed side by side as buttons for selecting a mental fatigue degree.

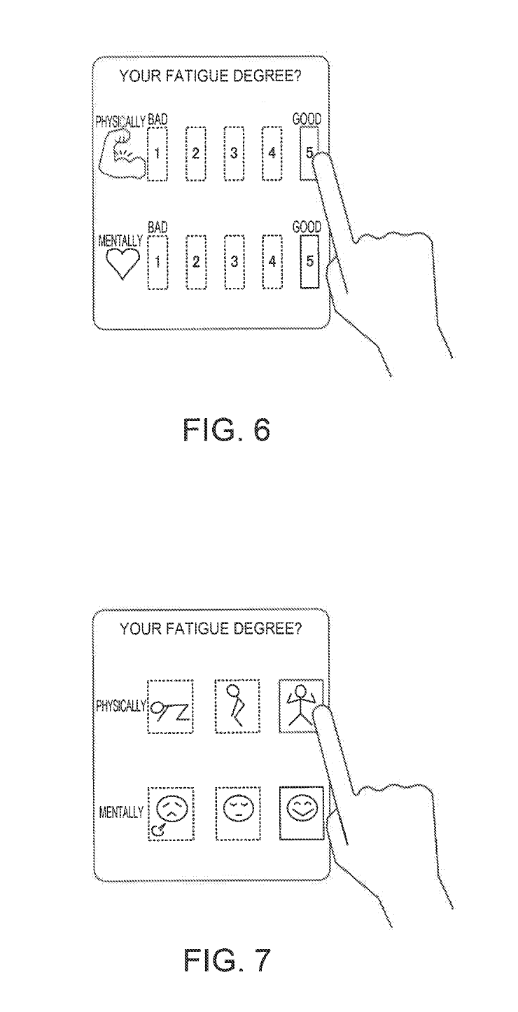

The display section 25 of the information terminal 2 may display an input screen as illustrated in FIG. 6 as an input screen. In an example illustrated in FIG. 6, the user may select one of five-step fatigue degrees such as “1”, “2”, “3”, “4”, and “5”, as a physical fatigue degree, and may select one of five-step fatigue degrees such as “1”, “2”, “3”, “4”, and “5”, as a mental fatigue degree.

### 1-11-3. Input Screen Using Icon

The display section 25 of the information terminal 2 may display an input screen as illustrated in FIG. 7 as an input screen. In an example illustrated in FIG. 7, three-step fatigue degrees are expressed by icons. The user can input a fatigue degree by selecting the icons.

On the input screen illustrated in FIG. 7, icons expressing a physical fatigue degree with body poses are employed, and icons expressing a mental fatigue degree with human facial expressions are employed. If these icons are used, the user can smoothly report a fatigue degree thereof without using languages.

### 1-11-4. Other Input Screens

The display section 25 of the information terminal 2 may display both of the slide bars (FIG. 4) and the icons (FIG. 7) on a single input screen. In this case, the display section 25 may change an icon in conjunction with a slide position of the slide bar.

### 1-12. Principle of Course Recommendation Process

In the present system, the reason why a physical fatigue degree is differentiated from a mental fatigue degree is that, even if fatigue degrees are the same as each other, an event suitable for the user differs depending on a ratio between physical fatigue and mental fatigue.

Therefore, the processing section 31 of the server 4 classifies a combination of physical fatigue and mental fatigue into the following four categories, and determines a recommended event for each category. Hereinafter, the four categories (1) to (4) and examples of recommended events will be described.

(1) In a case where both of a physical fatigue degree and a mental fatigue degree of the user are low, a relatively hard event (for example, a build-up run or an interval run) is determined as a recommended event.

(2) In a case where both of a physical fatigue degree and a mental fatigue degree of the user are high, an event (for example, a slow sprint run or rest) causing a relatively low load is determined as a recommended event.

(3) In a case where a physical fatigue degree of the user is high, and a mental fatigue degree of the user is low, an event (for example, a slow pace run) causing easy recovery of physical fatigue is determined as a recommended event.

(4) In a case where a physical fatigue degree of the user is low, and a mental fatigue degree of the user is high, an event (for example, LSD) causing easy recovery of mental fatigue is determined as a recommended event. The LSD is an event in which an instantaneous load is lowered, and running is performed in a relaxing manner for a long period of time.

The processing section 31 of the server 4 determines a recommended course for the user on the basis of recommended events determined according to the policies (1) to (4), the present position of the user, weather information for an area to which the present position belongs, traffic information for the area, and the database 350.

### 1-13. Body Condition Evaluation in Server (Physical Fatigue)

For example, the processing section 31 of the server 4 acquires a state of the user (distinction between sleeping, standing, stoppage, walking, and stair climbing) at each time point for 24 hours and a heart rate of the user at each time point for 24 hours on the basis of log data (mainly, acceleration data and heart rate data) for last 24 hours.

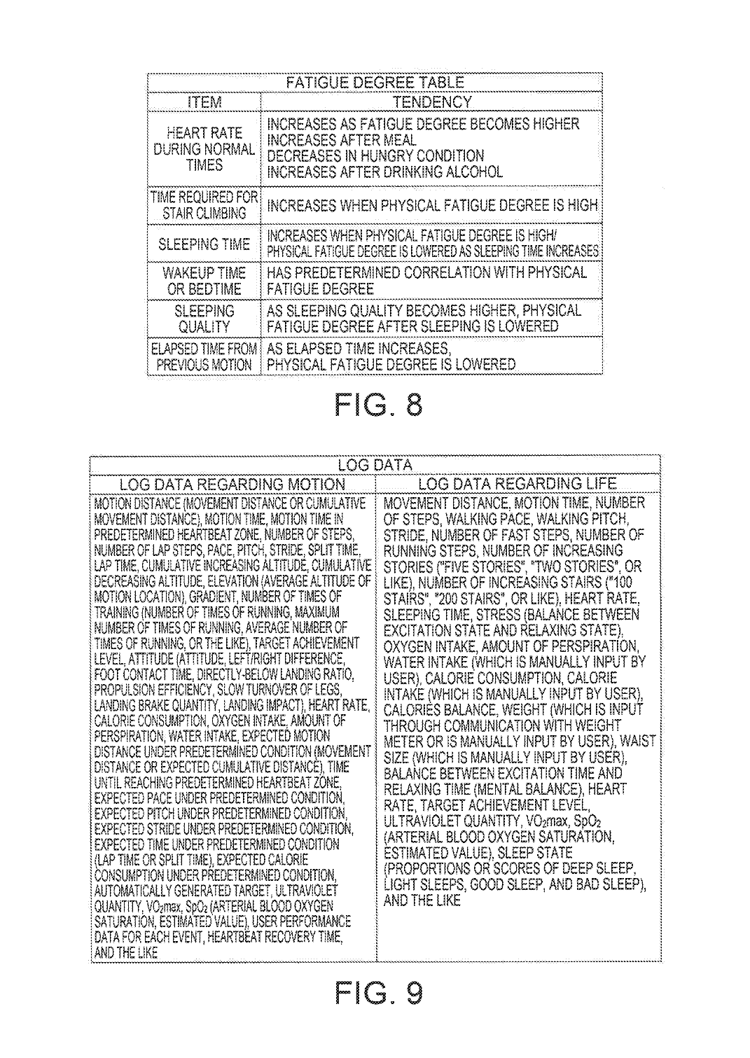

The processing section 31 of the server 4 computes a fatigue degree of the user at the present time (before training) according to the state of the user and the heart rate of the user by referring to, for example, a fatigue degree table illustrated in FIG. 8.

Here, the fatigue degree table illustrated in FIG. 8 is stored in, for example, the storage section 34 of the server 4 in advance. In FIG. 8, a fatigue degree is expressed by words, but an actual fatigue degree table is formed of a table for calculating a physical fatigue degree or a mental fatigue degree as a numerical value, for example, according to a combination of a heart rate of the user and a state of the user.

The processing section 31 calculates, for example, a physical fatigue degree or a mental fatigue degree for each hour on the basis of the log data for last 24 hours and the fatigue degree table, and sets a total of the calculated fatigue degrees (comprehensive fatigue degree) as a fatigue degree at the present time.

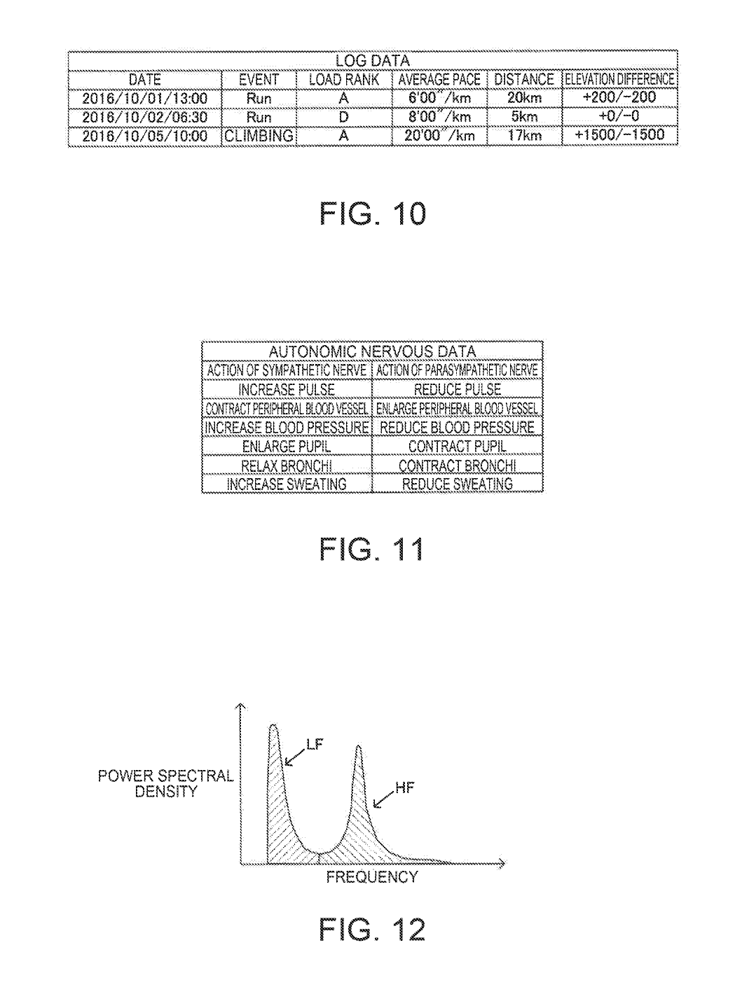

The processing section 31 estimates a physical fatigue degree which is not solved and remains until the present time on the basis of a load rank added to log data for last one month. FIG. 10 illustrates an example of log data added with a load rank. A load rank is added to each training event included in the log data. The load rank is a value relatively indicating the magnitude of a load (which leads to a fatigue degree) imposed on the user by a training event. Particularly, a higher load rank is added to a physical fatigue degree in which a training event is more unlikely to be solved even if time elapses. By referring to these load ranks, the processing section 31 estimates that a physical fatigue degree which is not solved and remains until the present time becomes higher as events with a high load rank becomes more, and time spent for an event with a high load rank increases. As mentioned above, the processing section 31 can calculate a fatigue degree of the user at the present time with high accuracy on the basis of log data with a load rank.

The processing section 31 adds a load rank to log data (evaluation of a load rank), for example, whenever log data is uploaded. The processing section 31 may set a criterion of a load rank for each user, and may set a criterion of a load rank to be common to all users.

For example, the processing section 31 calculates a self-best pace with respect to log data included in a log data list of the user. In this case, the processing section 31 adds a higher load rank to a pace among paces included in the log data list as a difference between the self-best pace and the pace becomes smaller, and writes the load rank to a corresponding location of the log data list (refer to FIG. 10). In the example illustrated in FIG. 10, load ranks are indicated by alphabets such as A, B, and C. In the example illustrated in FIG. 10, A indicates a high load, and the rank A and the rank D are displayed.

The processing section 31 may determine whether or not the user drank alcohol the day before the present time, for example, on the basis of log data regarding the life included in the log data list of the user, and may reflect a result of the determination in a fatigue degree of the user at the present time. Here, the determination of whether or not the user drank alcohol may be performed, for example, on the basis of whether or not heart rates during sleeping in the previous nighttime is considerably higher than (exceeds a threshold value) an average heart rate of the user during sleeping (for example, an average heart rate for last one month). The processing section 31 may determine a sleeping period on the basis of log data regarding the life. For example, the processing section 31 may detect whether or not the user at each time point is in a stable state on the basis of acceleration data included in log data at each time point in the nighttime, and may determine a period in which a stable state is continuously detected, and which has a length of a threshold value or more, as being a sleeping period. In a case where information regarding a sleeping period is already included in log data received by the server 4, the processing section 31 of the server 4 may omit determination of a sleeping period.

### 1-14. Body Condition Evaluation in Server (Mental Fatigue)

The processing section 31 of the server 4 calculates a mental balance between the sympathetic nerve and the parasympathetic nerve by analyzing, for example, pulse wave data included in log data regarding the life for last 24 hours in order to calculate a mental fatigue degree of the user at the present time (before training). In a case where information regarding a mental balance is already included in log data received by the server 4, the processing section 31 of the server 4 may omit computation of a mental balance.

Here, it is said to be that a mental balance has an appropriate value (ideal balance) for each user and each user's state (a sleeping or awakening state), and the mental balance tends to be deviated from the ideal balance as a mental fatigue degree of the user becomes higher.

Therefore, the processing section 31 calculates an ideal balance of a user for each time point for last 24 hours on the basis of, for example, log data of the user (particularly, log data indicating a state of the user) for last 24 hours, and user physical data of the user. The processing section 31 calculates a deviation between a mental balance (actually measured mental balance) included in the log data of the user and the ideal balance for each time point. The processing section 31 computes a value obtained by multiplying an average value of deviations at the respective time point by a predetermined coefficient, as a mental fatigue degree of the user at the present time. Details of a deviation calculation process will be described later.

A method of computing a mental balance on the basis of pulse data included log data may include above-described R-R Interval (RRI). For example, the processing section 31 performs a statistical process on a temporal change curve (pulse wave) of pulse data in a time series through fast Fourier transform (FFT) so as to calculates a power spectrum in a frequency domain, and computes a ratio between a low frequency component LF and a high frequency component HF appearing in the power spectrum as a mental balance. FIG. 12 is a schematic graph illustrating a power spectrum of LF and HF.

Herein, a description has been made of the method of computing a mental balance on the basis of an output (pulse data) from the pulse sensor 115, but the processing section 31 may compute a mental balance on the basis of an output from another sensor. FIG. 11 illustrates general data showing the influence which the sympathetic nerve and the parasympathetic nerve exert on the user's body. As illustrated in FIG. 11, since a mental balance also influences bodily functions other than a pulse, the processing section 31 can compute a mental balance on the basis of outputs from sensors other than the pulse sensor 115, the data illustrated in FIG. 11, or a computation formula or a table obtained by using the data.

### 1-15. Comprehensive Body Condition Evaluation in Server

The processing section 31 of the server 4 calculates a comprehensive fatigue degree by using both of a fatigue degree reported by the user and a fatigue degree computed by the processing section 31.

In a case where a mental balance computed on the basis of RRI is deviated from an ideal mental balance, the processing section 31 of the server 4 may calculate a difference between the computed mental balance and the ideal mental balance. The processing section 31 may add the calculated difference to log data list of the user as a stress index.

### 1-16. Deviation Calculation Process in Electronic Apparatus

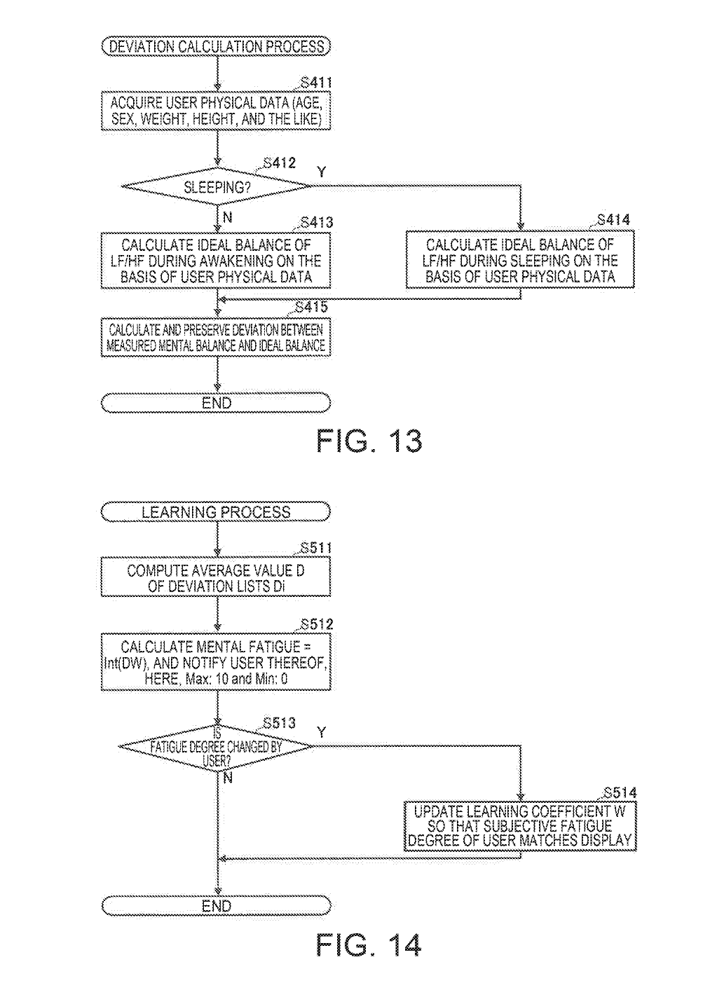

FIG. 13 illustrates a flow of a deviation calculation process.

In the above description, the process (deviation calculation process) of calculating a deviation between a mental balance of the user and an ideal mental balance is performed by the processing section 31 of the server 4, but may be performed by the processing section 120 of the electronic apparatus 1. In other words, the processing section 120 of the electronic apparatus 1 may calculate a deviation at each time point within the user's daily life, may cause the deviation at each time point to be included in log data, and may upload the log data to the server 4 via the information terminal 2.

Herein, a case is assumed in which a deviation calculation process is performed by the processing section 120 of the electronic apparatus 1. The flow illustrated in FIG. 13 is assumed to be periodically (for example, every minute) executed in a period in which the life logger function is developed in the electronic apparatus 1. Hereinafter, each step in FIG. 13 will be described.

First, the processing section 120 refers to user physical data stored in the storage section 130 (S411). The user physical data includes, for example, the age, the sex, a weight, and a height of the user.

Next, the processing section 120 determines whether or not the user is sleeping on the basis of acceleration data output from the acceleration sensor 113 (S412).

In a case where it is determined that the user is not sleeping (S412N), the processing section 120 calculates an ideal mental balance during awakening on the basis of the user physical data (S413).

In a case where it is determined that the user is sleeping (S412Y), the processing section 120 calculates an ideal mental balance during sleeping on the basis of the user physical data (S414).

The processing section 120 computes a mental balance of the user at the present time (or a certain time point in a predetermined period) according to the method of the above-described RRI on the basis of pulse data within a predetermined period including the present time, computes a difference between the computed mental balance and the ideal mental balance calculated in step S411 as a deviation, writes the deviation to the storage section 130 as one of log data regarding the life along with time data, and completes the flow (S415).

### 1-17. Learning Process in Server

FIG. 14 is a flow of a learning process performed by the processing section 31 of the server 4. Hereinafter, each step in FIG. 14 will be described.

First, the processing section 31 computes, for example, an average value D of deviation lists included in log data for last 24 hours (S511). Here, the deviation lists included in the log data for last 24 hours are deviations (time-series data of deviations) at respective time points for last 24 hours.

Next, the processing section 31 calculates a mental fatigue degree according to, for example, a computation formula of Int(DW), notifies the user of the calculated fatigue degree (for example, by displaying the input screens in FIGS. 4 to 7), and receives a report of a fatigue degree (input of a fatigue degree) from the user (S512). However, the processing section 31 sets a predefined initial value (default value) to a coefficient W at step S512 performed for the first time. Here, the operator “Int(A)” is used to convert “A” into an integer with appropriate magnitude from 0 to 10.

Next, the processing section 31 determines whether or not the fatigue degree reported by the user is different from the calculated fatigue degree, that is, the fatigue degree reported by the user has been changed (S513). In a case where the fatigue degree has been changed (S513Y), the coefficient W of the computation formula is changed so that the fatigue degree calculated according to the computation formula matches the reported fatigue degree, and the flow is completed (S514).

On the other hand, in a case where the fatigue degree reported by the user has not been changed from the calculated fatigue degree (S513N), the processing section 31 completes the flow without changing the coefficient W of the computation formula.

According to the above-described learning process, since the coefficient W of the computation formula is periodically reexamined, and is appropriately modified, a mental fatigue degree calculated according to the computation formula can be caused to approach a mental fatigue degree felt by the user.

According to the above-described learning process, a fatigue degree actually felt by the user can be reflected in determination of a recommended course and a recommended event.

For example, thereafter, in a case where a mental fatigue degree (that is, a mental fatigue degree included in log data) calculated according to the computation formula is high (that is, in a case where the user feels strong mental fatigue) the processing section 31 of the server 4 determines an event causing a low load as a recommended event for the user, and determines a course appropriate for the event as a recommended course for the user. Details of the course recommendation process will be described later.

On the other hand, in a case where a mental fatigue degree (that is, a mental fatigue degree included in log data) calculated according to the computation formula is low (that is, in a case where the user does not greatly feel mental fatigue) the processing section 31 of the server 4 determines an event causing a high load as a recommended event for the user, and determines a course appropriate for the event as a recommended course for the user. Details of the course recommendation process will be described later.

### 1-18. Training Event

The processing section 31 of the server 4 determines a recommended course for the user by using the above-described body condition information of the user. Herein, a description will be made of a case where the processing section 31 determines a training event (hereinafter, referred to as a “recommended training event” or a “recommended event”) appropriate for the user, and determines a course (recommended course) appropriate for the recommended event. Herein, several training events accompanied by movement on a course are assumed to be training events performed by the user. As described above, the body condition information includes at least one of information regarding a mental state (mental fatigue degree) of the user and information regarding a physical state (physical fatigue degree) of the user.

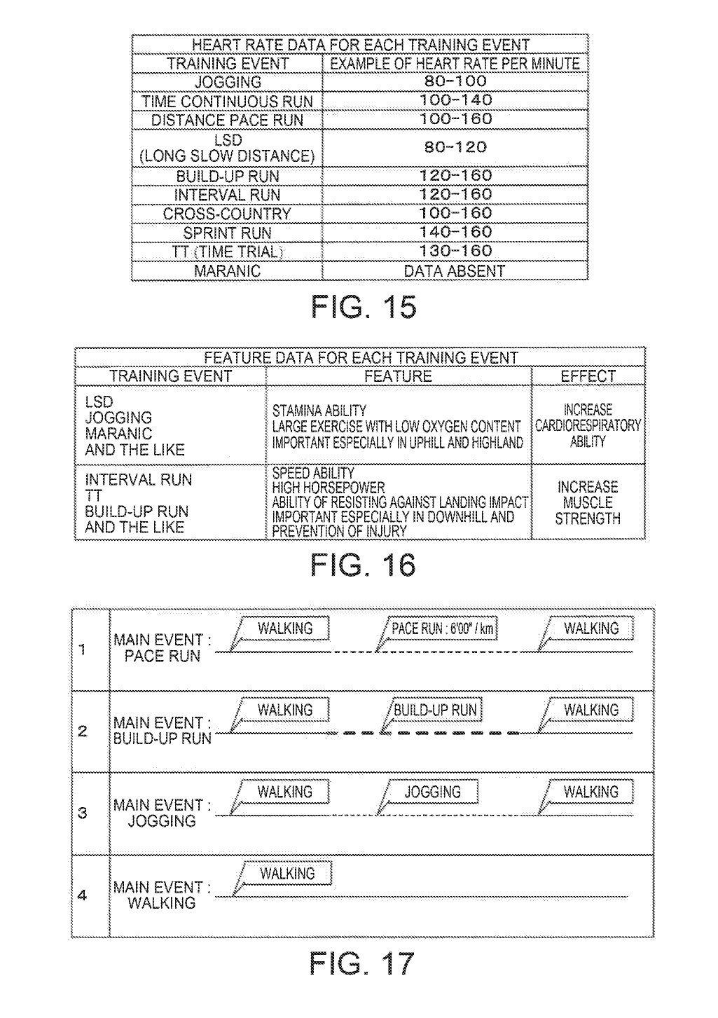

FIG. 15 illustrates examples of training events (candidates of training events) which may be candidates of recommended events. As illustrated in FIG. 15, training event candidates include, for example, jogging, a time continuous run, a pace run, long slow distance (LSD), a build-up run, an interval run, cross-country, a sprint run, time trial (TT), maranic, and walking. FIG. 15 illustrates a numerical value (criterion) of a heart rate for each event.

FIG. 16 is a table in which training events which may be recommended event candidates are classified according to features thereof. In other words, the training events may be classified into events for increasing cardiorespiratory ability and events for increasing speed ability. For example, LSD, jogging, and maranic are included in events for increasing cardiorespiratory ability, and an interval run, TT, and a build-up run are included in events for increasing speed ability.

The processing section 31 of the server 4 determines a recommended event for the user and also determines a recommended course by taking into consideration a fatigue degree (a physical fatigue degree and a mental fatigue degree) of the user, and the information illustrated in FIGS. 15 and 16.

For example, the storage section 34 of the server 4 stores a table (not illustrated) in which a combination of a mental fatigue degree and a physical fatigue degree is correlated with a recommended event in advance, and the processing section 31 of the server 4 determines a recommended event by referring to the table according to a mental fatigue degree and a physical fatigue degree of the user. The table may be a table in which the above-described four categories (1) to (4) are respectively correlated with recommended events.

Since the storage section 34 of the server 4 stores the database 350 for a plurality of courses in advance, the processing section 31 of the server 4 determines a recommended course for the user by referring to the database 350 on the basis of the determined recommended event and a position of the user. For example, a course in which a distance from a position of the user is within a predetermined distance range and which is appropriate to perform the recommended event is determined as a recommended course for the user.

The processing section 31 of the server 4 generates information (browsing data) indicating the determined recommended event and recommended course, transmits the information to the information terminal 2, and displays the recommended event and the recommended course on the display section 25 of the information terminal 2. The display of the recommended event and the display of the recommended course may be performed on separate screens, and may be performed on the same screen.

### 1-19. Display Screen (List Display) for Recommended Event

FIG. 17 is a diagram illustrating an example a display screen for a recommended event.

A plurality of recommended events are arranged side by side in a predetermined direction (a direction recognized as a vertical direction when viewed from the user in FIG. 17) on the display screen so as to be viewed by the user.

In the example illustrated in FIG. 17, as several recommended events, a warm-up event (walking) and a cool-down event (walking) which are effective if performed along with the recommended events are added before and after a main recommended event, but the addition of the warm-up event (walking) and the cool-down event may be omitted. Muscle training may be added instead of warm-up or cool-down. Therefore, the example illustrated in FIG. 17 can be said to be a list of “recommended training menus”.

On the display screen illustrated in FIG. 17, a main recommended event in the recommended training menu displayed in the first row is a “pace run of 60′ 00″”, a main recommended event in the recommended training menu displayed in the second row is a “build-up run”, a main recommended event in the recommended training menu displayed in the third row is “jogging”, and a main recommended event in the recommended training menu displayed in the fourth row is “walking”.

The order of arranging a plurality of recommended events on the display screen is the order of higher scores (an example of an index indicating a recommendation degree). A score of a recommended event is a rank, a numerical value, or the like indicating the appropriateness (recommendation degree) for the user, and is calculated by the processing section 31 of the server 4, for example, on the basis of a feature (FIG. 16) of each training event and log data of the user.

Here, on the display screen, different recommended events are expressed by different curve images (linear images in FIG. 17). In the example illustrated in FIG. 17, the “pace run” is displayed by a dashed line image with a standard line width, the “build-up run” is displayed by a dashed line image with a line width larger than the standard line width, the “jogging” is displayed by a dashed line image with a line width smaller than the standard line width, and the “walking” is displayed by a solid line image. In FIG. 17, the events are displayed by text.

As mentioned above, if different recommended events are displayed by different visual expressions (linear images with different line types or line widths), the user can intuitively recognize a recommended event for the user at the present time, and can easily compare two or more recommended events appropriate for the user at the present time with each other.

Herein, the linear images with different line types and line widths are allocated to different recommended events, but linear images with different line colors may be allocated to different recommended events, linear images which blink in different patterns may be allocated to different recommended events, and linear images with different textures may be allocated to different recommended events. In other words, curve images with at least one of different line colors, line widths, line types, temporally changing patterns, and textures may be employed as visual expressions for differentiating recommended events from each other.

Herein, curve images (the linear images in FIG. 17) extending in the horizontal direction when viewed from the user are employed as visual expressions, but visual expressions other than simple curve images, that is, visual expressions such as tube images, block images, rope images, wire images, ribbon images, arrow marks, block image sequences, and mark images may be employed.

On the display screen, standard time or a standard distance required for a recommended event may be reflected in lengths of visual expressions (various images) in the display screen. In this case, the user can intuitively understand a criterion of time or a distance required for each recommended event on the basis of the lengths of the visual expressions (various images).

Herein, a plurality of recommended events are simultaneously displayed on a single display screen, but a plurality of recommended events may be displayed in order (cyclically) on a single display screen. In this case, a screen may be automatically changed for a predetermined time (for example, one second), and a screen may be changed at a timing at which the user performs a predetermined operation.

### 1-20. Display Screen (Map Display) for Recommended Course

FIG. 18 is a diagram illustrating an example of a display screen for a recommended course.

Respective summaries of a plurality of recommended courses are arranged and displayed in a predetermined direction (a vertical direction when viewed from the user in FIG. 18) so as to be viewed by the user in a predetermined region (a left region when viewed from the user in FIG. 18) of the display screen.

In the example illustrated in FIG. 18, recommended events appropriate to be performed in the recommended courses are respectively assigned to the plurality of recommended courses. Hereinafter, a recommended course assigned with a recommended event will be simply referred to as a “recommended course” or a “recommended course with a recommended event”.

On the display screen, a recommended course displayed in the first row is “A Park”, and a recommended event assigned to this recommended course is a “pace run”.

On the display screen, a recommended course displayed in the second row is “B Park”, and a recommended event assigned to this recommended course is a “build-up run”.

On the display screen, a recommended course displayed in the third row is “C Park”, and a recommended event assigned to this recommended course is “jogging”.

On the display screen, a recommended course displayed in the fourth row is “D River Bed”, and a recommended event assigned to this recommended course is “walking”.

The order of arranging a plurality of recommended courses on the display screen is the order of higher scores. A score of a recommended course is a score indicating the appropriateness (recommendation degree) for the user, and is calculated by the processing section 31 of the server 4. A specific example of a score calculation formula will be described later.

Here, on the display screen, each recommended course is expressed by a curve image indicating a shape of the course.

On the display screen, each recommended course is displayed by a visual expression corresponding to a recommended event to be performed in the recommended course. In the example illustrated in FIG. 18, a recommended course in which the “pace run” is to be performed is displayed by a dashed line image with a standard line width, a recommended course in which the “build-up run” is to be performed is displayed by a dashed line image with a line width larger than the standard line width, a recommended course in which the “jogging” is to be performed is displayed by a dashed line image with a line width smaller than the standard line width, and a recommended course in which the “walking” is to be performed is displayed by a solid line image.

In other words, in the example illustrated in FIG. 18, at least one recommended course includes a first recommended course (A Park) corresponding to a first training event (pace run), a second recommended course (B Park) corresponding to a second training event (build-up run) which is different from the first training event, a third recommended course (C Park) corresponding to a third training event (jogging) which is different from the first and second training events, and a fourth training event (walking) which is different from the first to third training events.

The first recommended course (A Park) is displayed by a first visual expression (a dashed line image with a standard line width) corresponding to the first training event, the second recommended course (B Park) is displayed by a second visual expression (a dashed line image with a line width larger than the standard line width) corresponding to the second training event, the third recommended course (C Park) is displayed by a third visual expression (a dashed line image with a line width smaller than the standard line width) corresponding to the third training event, and the fourth recommended course (D River Bed) is displayed by a fourth visual expression (solid line image) corresponding to the fourth training event.

As mentioned above, if each recommended course is displayed by a visual expression corresponding to a recommended event to be performed in the recommended course, the user can visually recognize both of the recommended course and the recommended event without depending on a linguistic expression.

Herein, the linear images with different line types and line widths are allocated to different recommended events, but linear images with different line colors may be allocated to different recommended events, linear images which blink in different patterns may be allocated to different recommended events, and linear images with different textures may be allocated to different recommended events. In other words, curve images with at least one of different line colors, line widths, line types, temporally changing patterns, and textures may be employed as visual expressions for differentiating recommended events from each other.

Herein, curve images are employed as visual expressions, but visual expressions other than simple curve images, that is, visual expressions such as tube images, block images, rope images, wire images, ribbon images, arrow marks, block image sequences, and mark images may be employed.

On the display screen, standard time or a standard distance required for each recommended course with a recommended event may be reflected in sizes of visual expressions (various images) in the display screen. In this case, the user can intuitively understand a criterion of time or a distance required for each recommended course with a recommended event on the basis of the sizes of the visual expressions (various images).

Herein, a plurality of recommended courses are simultaneously displayed on a single display screen, but a plurality of recommended courses may be displayed in order (cyclically) on a single display screen. In this case, a screen may be automatically changed for a predetermined time (for example, one second), and a screen may be changed at a timing at which the user performs a predetermined operation.

Here, in order to notify the user of a positional relationship among a plurality of recommended courses, a map of an area to which the plurality of recommended courses belong is displayed in a predetermined region (a right region when viewed from the user) of the display screen illustrated in FIG. 18.

For example, the present position of the user or paths until reaching the plurality of recommended courses from the present position of the user are displayed on the map. In this case, when the user selects one of the plurality of recommended courses as a training course, the user can refer to a distance or a path from the present position to each of the plurality of recommended courses. When the user selects a training course, the user can refer to a distance of each of the plurality of recommended courses (the entire length of the course) on the map.

Also on the map, each of the plurality of recommended courses is displayed by a visual expression corresponding to a recommended event assigned to the recommended course. In other words, also on the map, each of the plurality of recommended courses is displayed by a visual expression (a visual expression corresponding to the type of activity) corresponding to the recommended event.

Therefore, the user can easily understand a recommended event assigned to each of a plurality of recommended courses on the map.

Information related to training or information which is necessary for movement to a course is preferably posted on the map. For example, the information includes a landmark, a toilet, a shower facility, a parking lot, a bicycle parking area, a convenience store, a sports shop, a water garden, and a rest area. Information to be displayed on the map may be selected by the processing section 31 of the server 4 according to at least one of a recommended event and a recommended course to be displayed on the map.

### 1-21. Display Screen (Overlapping Display) for Recommended Course

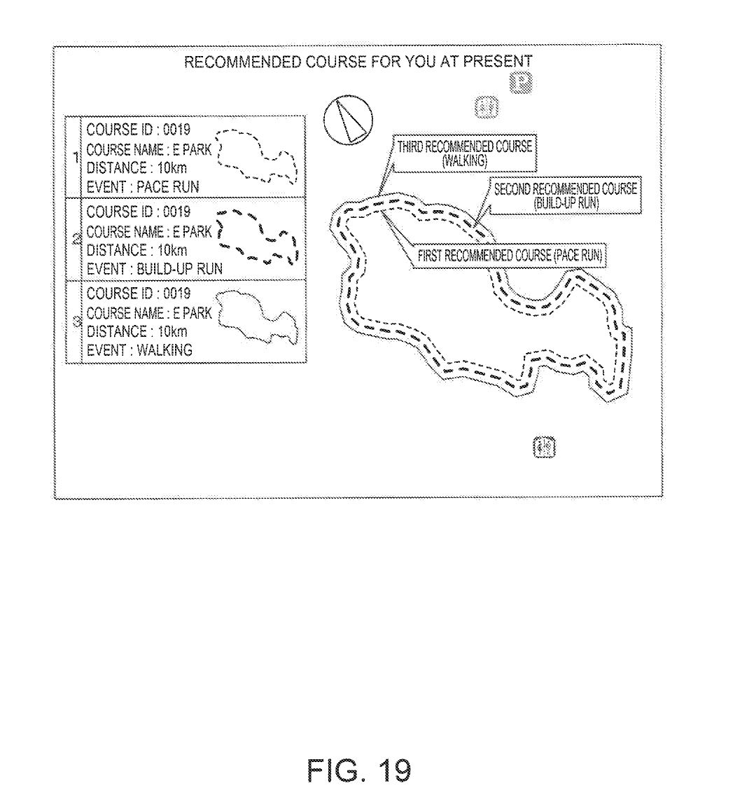

In a case where a plurality of recommended events are assigned to the same recommended course, that is, in a case where a course is used in common, and a plurality of the recommended courses with different recommended events are displayed on the same screen, for example, as illustrated in FIG. 19, preferably, the plurality of recommended courses are displayed in an overlapping manner, and each of the plurality of recommended courses is displayed by a visual expression corresponding to a recommended event assigned to the recommended course. FIG. 19 illustrates an example in which a curve image is used as a visual expression of a recommended course, and the line type of the curve image is set as the line type corresponding to a recommended event. If a plurality of recommended courses are caused to completely overlap each other on the same screen, the recommended courses cannot be differentiated from each other, and thus the plurality of recommended courses are preferably disposed to be appropriately deviated from each other so that the user can differentiate the plurality of recommended courses from each other as illustrated in FIG. 19.

### 1-22. Display Screen (Section Display) for Recommended Course

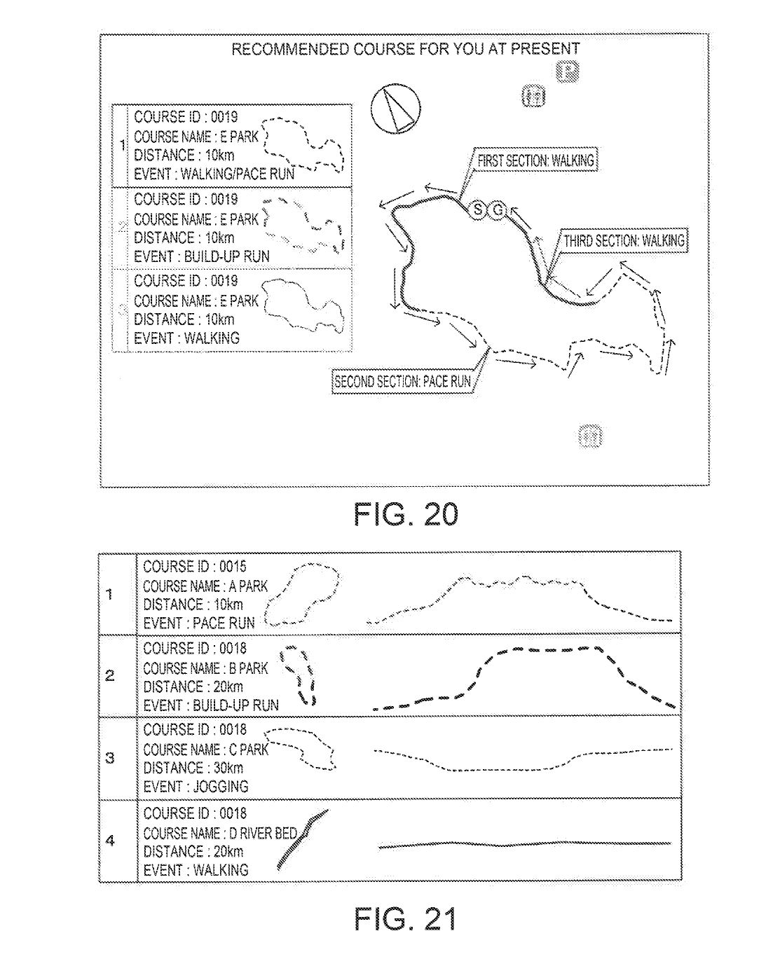

In a case where recommended events are different from each other depending on sections in the same recommended course, for example, as illustrated in FIG. 20, a visual expression (a line type, a line color, or the like) of each section of the recommended course is preferably displayed by a visual expression corresponding to a recommended event for the section. Here, in the example illustrated in FIG. 20, a mark “S” is displayed at a start point of the recommended course, and a mark “G” is displayed at a goal point of the recommended course. Hereinafter, a start point will be referred to as a start point S, and a goal point will be referred to as a goal point G.

First, in the example illustrated in FIG. 20, since a recommended event assigned to a first section with the start point S as a starting point is “walking”, the first section is displayed by a visual expression (solid line image) corresponding to the “walking” event.

In the example illustrated in FIG. 20, since a recommended event assigned to a second section with the start point S as a starting point is a “pace run”, the second section is displayed by a visual expression (a dashed line image with a standard line width) corresponding to the “pace run” event.

In the example illustrated in FIG. 20, since a recommended event assigned to a third section with the goal point G as an ending point is “walking”, the third section is displayed by a visual expression (solid line image) corresponding to the “walking” event.

A list of recommended courses is displayed in the score order in a predetermined region (a left region when viewed from the user) of the display screen illustrated in FIG. 20. If the user taps one of the recommended courses with the finger, only the tapped recommended course is brought into a selection state (in a high contrast state in FIG. 20), and the recommended courses which are not tapped are brought into a non-selection state (in a gray-out state in FIG. 20). The content (for example, the recommended event assigned to the recommended course) of the recommended course in a selection state is displayed on the map in a predetermined region (a right region when viewed from the user) of the display screen, and the content of the recommended courses in a non-selection state is not displayed on the map. As illustrated in FIG. 20, a traveling direction in the course may be indicated by arrows or the like, and information regarding a facility around the course such as a parking lot may also be displayed on the map.

### 1-23. Display Screen (Elevation Map) for Recommended Course

For example, as illustrated in FIG. 21, a recommended course may be displayed as a map (elevation map) indicating an elevation of each point forming the recommended course. In other words, the recommended course may be displayed to overlap the elevation map. The elevation map may be displayed by a visual expression corresponding to a recommended event assigned to the recommended course. Here, the elevation map is a map called a topographical map or a section navigation map, and is a map indicating a distribution of elevations in the recommended course.

In the elevation map illustrated in FIG. 21, an elevation coordinate axis is disposed in an upward direction when viewed from the user, a position coordinate axis is disposed in a rightward direction when viewed from the user, and an elevation at each point of the course is displayed by a curve image. The elevation map of the recommended course is displayed with a line type corresponding to a recommended event assigned to the recommended course.

On the display screen, since a recommended course displayed in the first row is “A Park”, and a recommended event assigned to this recommended course is a “pace run”, the recommended course is displayed by a visual expression (a dashed line image with a standard line width) corresponding to the pace run event.

On the display screen, since a recommended course displayed in the second row is “B Park”, and a recommended event assigned to this recommended course is a “build-up run”, the recommended course is displayed by a visual expression (a dashed line image with a line width larger than the standard line width) corresponding to the build-up run event.

On the display screen, since a recommended course displayed in the third row is “C Park”, and a recommended event assigned to this recommended course is “jogging”, the recommended course is displayed by a visual expression (a dashed line image with a line width smaller than the standard line width) corresponding to the jogging event.

On the display screen, a recommended course displayed in the fourth row is “D River Bed”, and a recommended event assigned to this recommended course is “walking”, the recommended course is displayed by a visual expression (solid line image) corresponding to the walking event.

Herein, the elevation map is expressed by a curve image, but visual expressions other than a simple curve image, that is, visual expressions such as tube images, block images, rope images, wire images, ribbon images, arrow marks, block image sequences, and mark images may be employed.

### 1-24. User Operation Screen Change

Hereinafter, a description will be made of screen change of the display section 170 of the electronic apparatus 1.

Herein, a case is assumed in which the server 4 cooperates with the electronic apparatus 1 by using a program (application program) executed in the information terminal 2 and a program (application program) executed in the electronic apparatus 1.

The user operates the information terminal 2 before training so as to incorporate information regarding a recommended course with a recommended event into the information terminal 2 from the server 4, and transmits the information to the electronic apparatus 1 from the information terminal 2. The user mounts the electronic apparatus 1 on the body thereof, and starts training in a state of storing or mounting the information terminal 2 in or on a pocket of clothes or a waist belt. Therefore, the electronic apparatus 1 can also acquire information generated by the server 4 via the information terminal 2 as appropriate during training, and the electronic apparatus 1 can also transmit log data acquired during training to the server 4 via the information terminal 2 as appropriate.

In the present system, some of the functions of the electronic apparatus 1 may be installed on the information terminal 2 side, and some or all of the functions of the information terminal 2 may be installed on the electronic apparatus 1 side. Some or all of the functions of the information terminal 2 may be installed on the server 4 side, and some or all of the functions of the server 4 may be installed on the information terminal 2 side.

For example, in the present system, the processing section 120 of the electronic apparatus 1 operates as an acquisition section acquiring body condition information, but at least one sensor of the electronic apparatus 1 may operate as an acquisition section acquiring body condition information.

In a case where the operation section 150 is used to input body condition information, the operation section 150 may operate as an acquisition section.

In a case where the information terminal 2 has a function of acquiring body condition information, the operation section 23 of the information terminal 2 may operate as an acquisition section (for example, in a case where the operation section 23 is used to input body condition information).

In a case where the information terminal 2 has a function of acquiring body condition information, the communication section 22 of the information terminal 2 may operate as an acquisition section.

In a case where the information terminal 2 has a function of acquiring body condition information, the processing section 21 of the information terminal 2 may operate as an acquisition section.

In a case where the server 4 has a function of acquiring body condition information, the communication section 32 of the server 4 may operate as an acquisition section.

In the present system, at least one of the display section 170 and the sound output section 180 of the electronic apparatus 1 may operate as an output section presenting a recommended route, and at least one of the display section 25 and the sound output section 26 of the information terminal 2 may operate as an output section.

Sharing of functions in the electronic apparatus 1 (for example, function sharing between the processing section as a processor and the display section displaying a route) is not limited to that described here, and sharing of functions in the information terminal 2 (for example, function sharing between the processing section as a processor and the display section displaying a route) is not limited to that described here.

First, for example, as illustrated in FIG. 22, the user taps an icon 22A such as “training” displayed on a display screen of the display section 170 with the finger before training, so as to activate an application program of the electronic apparatus 1. The processing section 120 of the electronic apparatus 1 transmits data required for a course recommendation process of log data held in the electronic apparatus 1 and log data held in the information terminal 2, to the server 4 in a predetermined format via the information terminal 2 according to the application program. Next, the processing section 120 of the electronic apparatus 1 receives information such as a recommended course from the server 4 via the information terminal 2, and displays the information such as a recommended course on the display section 170.

Here, since a size of the display section 170 of the electronic apparatus 1 is smaller than a size of the display section 25 of the information terminal 2, the processing section 120 of the electronic apparatus 1 may display a simple screen as illustrated in FIG. 23 on the display section 170 as a screen displaying a recommended course or the like instead of the screens as illustrated in FIGS. 17 to 21.

The processing section 120 of the electronic apparatus 1 may scroll a screen in response to a slide operation using the user's finger in a case where all of a plurality of recommended courses are not included in the display section 25.

The processing section 120 of the electronic apparatus 1 may dispose a skip button 23A at the beginning of recommended courses when a plurality of recommended courses are displayed in a list form. In a case where there is no desired course among the plurality of recommended courses displayed in a list form, the user may tap the skip button 23A with the finger.

In a case where the skip button 23A is tapped, the processing section 120 of the electronic apparatus 1 determines that the user starts training, and determines a course and an event in which the user performs the training. The processing section 120 of the electronic apparatus 1 may determine a course and an event until a predetermined time elapses from starting of training even before the training is completed.

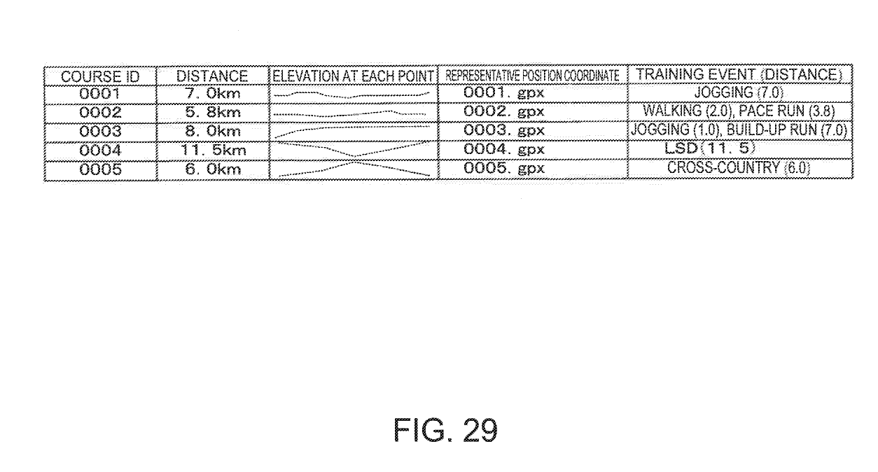

If the processing section 120 of the electronic apparatus 1 determines a course in which the user performs the training, in a case where the course is the same as any one of a plurality of recommended courses, the processing section 120 may develop the navigation function on the basis of course data (FIG. 29) of the recommended course, and may develop the life logger function and the performance monitor function (however, the life logger function may be normally developed).

Course data (FIG. 29) of a plurality of recommended courses is transmitted to the electronic apparatus from the server 4 via the information terminal 2, and is stored in the storage section 130 of the electronic apparatus 1, in advance. Details of the life logger function and the performance monitor function are the same as described above.

On the other hand, in a case where the determined course is not included in any of a plurality of recommended courses, the processing section 120 of the electronic apparatus 1 does not develop the navigation function, and develops only the life logger function and the performance monitor function (however, the life logger function may be normally developed).

The processing section 120 of the electronic apparatus 1 may determine a course, for example, on the basis of positioning data (latitude, longitude, a velocity vector, and the like) output from the GPS sensor 110. The processing section 120 of the electronic apparatus 1 may determine an event (event determination process), for example, on the basis of positioning data (a velocity vector and the like) output from the GPS sensor 110, and acceleration data output from the acceleration sensor 113.

The processing section 120 of the electronic apparatus 1 may allow the user to input a course instead of determining a course, and may allow the user to input an event instead of determining a training event.

After the training is completed, in a case where course data of the course in which the user has performed the training is new course data, the processing section 120 of the electronic apparatus 1 uploads the course data to the server 4 via the information terminal 2 along with log data acquired during training. Handling of the log data and the course data in the server 4 are the same as described above.

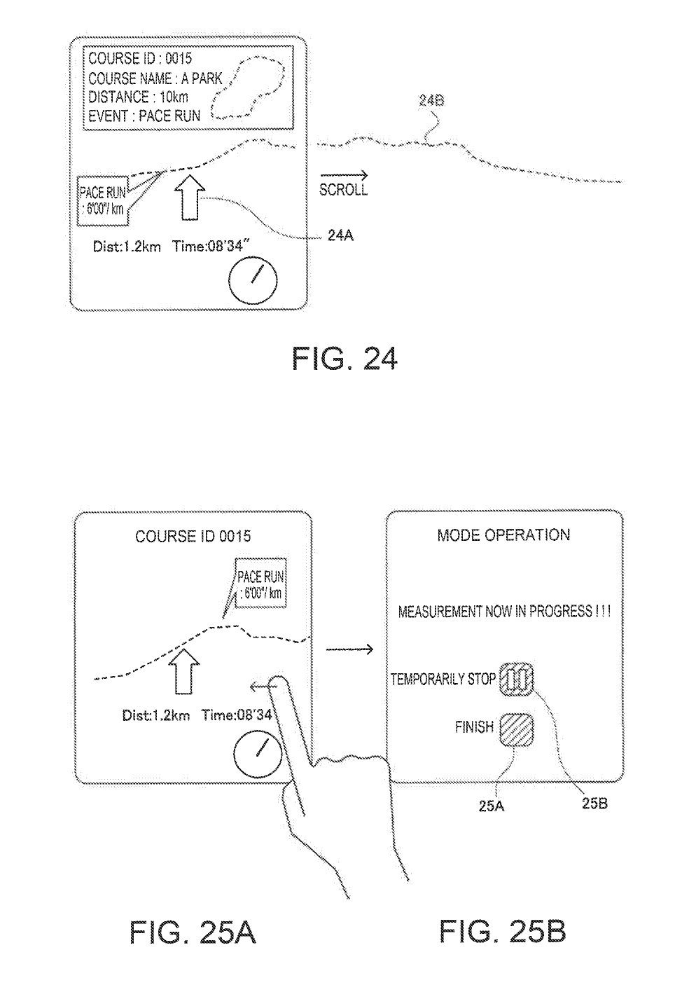

Here, if the navigation function is developed in the electronic apparatus 1 during training, a navigation screen is displayed on the display section 170. The navigation screen is as illustrated in FIG. 24, for example.

### 1-25. Navigation Screen (Elevation Map)

In a navigation screen illustrated in FIG. 24, a course in which the user is performing training is displayed as, for example, an elevation map 24B. In other words, the recommended course is displayed to overlap the elevation map 24B on the display section 170.

Here, the elevation map 24B is a map called a topographical map or a section navigation map, and is a map indicating a distribution of elevations in the course. In the elevation map 24B, a predetermined mark (arrow mark) 24A is added to a location corresponding to the present position of the user. If the user performs training, and thus a movement distance is increased, a position of the mark 24A in the elevation map 24B is changed.

Since a size of the display section 170 is restricted in the mounting type electronic apparatus 1, preferably, instead of the whole of the elevation map 24B being displayed on the display section 170, only a partial area including a traveling position of the user in the elevation map 24B is displayed on the display section 170, and the display target partial area is scrolled according to a change of the traveling position of the user. Preferably, a size of the partial area which is also a display target in the elevation map 24B can be changed through the user's operation (pinch-in or pinch-out) on the display section 170.

Here, also on the navigation screen, the elevation map 24B of the course is displayed by a visual expression corresponding to a training event performed in the course. In the example illustrated in FIG. 24, a training event performed by the user is a pace run, and thus the elevation map 24B is displayed by a visual expression (a dashed line image with a standard line width) corresponding to the pace run event.

The processing section 120 of the electronic apparatus 1 may sequentially display some log data (for example, a cumulative movement distance and a traveling time) on the navigation screen during the user's training. For example, a cumulative movement distance and a traveling time are displayed as numerical values along with text images such as “Dist” and “Time” in a region corresponding to a lower part when viewed from the user on the navigation screen. The numerical values are changed according to changes of a traveling distance and a traveling time of the user.

Thereafter, if the training is completed, the user inputs completion of the training (a notification of completion) to the electronic apparatus 1. Regarding inputting of a notification of completion, for example, if the user performs a slide operation on the display section 170 of the electronic apparatus 1 with the finger in a predetermined direction, the notification of completion may be input to the electronic apparatus 1. Alternatively, if the user makes a predetermined gesture with the arm on which the electronic apparatus 1 is mounted, a notification of completion may be input to the electronic apparatus 1. The predetermined gesture is, for example, a gesture of swinging the electronic apparatus 1 at acceleration of a predetermined level or more in a predetermined direction.

If the notification of training completion is input, the display section 170 of the electronic apparatus 1 changes a navigation screen (FIG. 25A) to an end screen (FIG. 25B). A text image for notification that measurement is in progress may be disposed on the end screen (FIG. 25B). The text image is, for example, a text image such as “measurement now in progress I”. In other words, whether or not measurement is in progress may be displayed on the end screen (FIG. 25B).

The user may tap a stop button 25A disposed on the end screen (FIG. 25B) with the finger so as to notify the electronic apparatus 1 of completion of training and thus to stop the navigation function and the performance monitor function of the electronic apparatus 1. If the stop button 25A is tapped, the processing section 120 of the electronic apparatus 1 writes and stores log data acquired until the present time from starting of the training to and in, for example, the storage section 130. If the training is temporarily stopped or completed, the text image such as “measurement now in progress!” on the end screen (FIG. 25B) is not displayed or is changed to a text image for notification of temporary stoppage or completion. The text image is, for example, a text image such as “temporarily stopped” or “completed”. In other words, whether or not measurement is in progress may be displayed on the end screen (FIG. 25B).

The user may tap a pause button 25B disposed on the end screen (FIG. 25B) with the finger so as to notify the electronic apparatus 1 of stoppage of training and thus to temporarily stop the navigation function and the performance monitor function of the electronic apparatus 1. In this state, the user can be temporarily deviated from the course and can take a rest.

When the user takes a rest, and then returns to the course, the user taps the pause button 25B disposed on the end screen (FIG. 25B) again with finger so as to notify the electronic apparatus 1 of resuming of the training and thus to resume the navigation function and the performance monitor function of the electronic apparatus 1. Preferably, the performance monitor function is stopped during the temporary stoppage, but the life logger function is not stopped.

If the user performs a notification of stoppage of training, the processing section 120 of the electronic apparatus 1 stops the navigation function and the performance monitor function, and if the user performs a notification of resuming of the training, the processing section 120 resumes the navigation function and the performance monitor function.

If the user performs a notification of resuming of the training, and then performs a notification of completion of the training, the processing section 120 of the electronic apparatus 1 connects log data regarding motion from starting of the training to stoppage thereof to log data regarding motion from resuming of the training to completion thereof, and stores the connected log data as log data regarding motion of the overall training.

The processing section 120 of the electronic apparatus 1 may monitor a difference between a position of the user before (right before) the training is stopped and a position of the user at the present time on the basis of positioning data output from the GPS sensor 110 after the training is stopped, and may determine that the training is completed (that is, the user forgets performing a notification of completion) even if a notification of completion of the training is not performed in a case where the difference exceeds a threshold value.

Alternatively, the processing section 120 of the electronic apparatus 1 may monitor a difference between a position of the user before (right before) the training is stopped and a position of the user at the present time on the basis of positioning data output from the GPS sensor 110 after the training is stopped, and may determine that the training is resumed (that is, the user forgets performing a notification of resuming) even if a notification of resuming of the training is not performed in a case where the difference exceeds a threshold value.

The processing section 120 of the electronic apparatus 1 may perform the determination on the basis of not a difference in a position of the user but a difference in a movement speed of the user.

In other words, the processing section 120 may monitor a difference between a movement speed of the user before (right before) the training is stopped and a movement speed of the user at the present time on the basis of positioning data output from the GPS sensor 110 after the training is stopped, and may determine that the training is completed (that is, the user forgets performing a notification of completion) even if a notification of completion of the training is not performed in a case where the difference exceeds a threshold value.

Alternatively, the processing section 120 may monitor a difference between a movement speed of the user before (right before) the training is stopped and a movement speed of the user at the present time on the basis of positioning data output from the GPS sensor 110 after the training is stopped, and may determine that the training is resumed (that is, the user forgets performing a notification of resuming) even if a notification of resuming of the training is not performed in a case where the difference exceeds a threshold value.

In a case where the above-described skip button 23A is tapped, and then training is completed, the processing section 120 of the electronic apparatus 1 may inquire of the user about the necessity of new registration of the training event performed by the user and the course in which the training has been performed. For example, the processing section 120 of the electronic apparatus 1 displays a screen (not illustrated) for inquiring about the necessity on the display section 170, and uploads data regarding the training event and the course to the server 4 via the information terminal 2 in a predetermined format in a case where the user inputs a request for new registration on the screen.

Herein, the linear images with different line types and line widths are allocated to different training events, but linear images with different line colors may be allocated to different training events, linear images which blink in different patterns may be allocated to different training events, and linear images with different textures may be allocated to different training events. In other words, curve images with at least one of different line colors, line widths, line types, temporally changing patterns, and textures may be employed as visual expressions for differentiating training events from each other.

Herein, an elevation map is expressed by a curve image, but visual expressions other than a simple curve image, that is, visual expressions such as tube images, block images, rope images, wire images, ribbon images, arrow marks, block image sequences, and mark images may be employed.

On the display screen, time or a standard distance required for a training event may be reflected in a size of the visual expression (curve image) in the display screen. In this case, the user can intuitively understand time or a distance required for a training event on the basis of the length of the visual expression (curve image). Actual time or distance may be reflected in a size of a section in which the user has moved, and scheduled time or scheduled distance may be reflected in a size of a section in which the user will move from now on.

### 1-26. Navigation Screen (Linear Image)

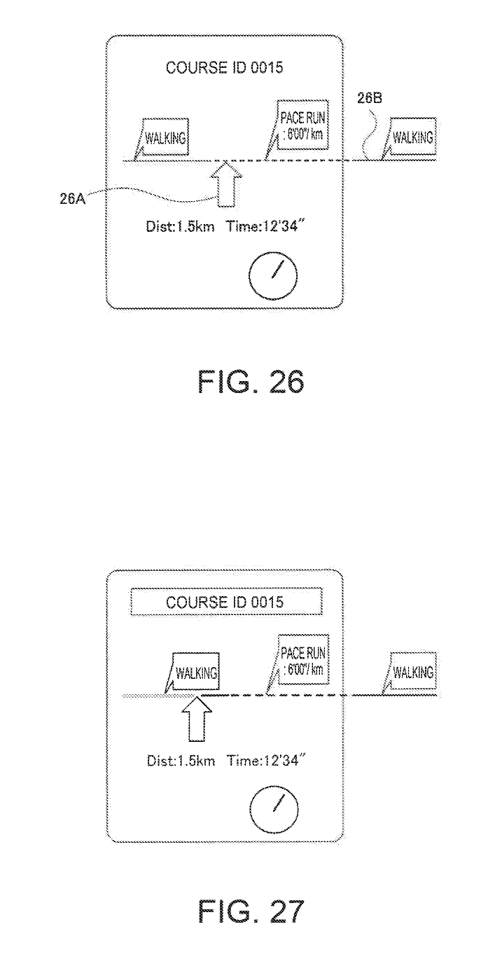

The processing section 120 of the electronic apparatus 1 may use, as a navigation screen, not only the screen illustrated in FIG. 24 but also, for example, a screen as illustrated in FIG. 26. In the screen illustrated in FIG. 26, a description of a portion common to the screen illustrated in FIG. 24 will be omitted.

A course in which the user is performing training is displayed by a linear image 26B on a navigation screen illustrated in FIG. 26, and a predetermined mark (arrow mark) 26A is added to a location corresponding to the present position of the user in the linear image 26B. If the user performs training, and thus a movement distance is increased, a position of the mark 26A in the linear image 26B is changed.

Here, in the example illustrated in FIG. 26, each section of a course is displayed by a visual expression corresponding to a training event performed in the section.

In the example illustrated in FIG. 26, since a training event performed in a first section is walking, the first section is displayed by a visual expression (solid line image) corresponding to the walking event.

In the example illustrated in FIG. 26, since a training event performed in a second section is a pace run, the second section is displayed by a visual expression (a dashed line image with a standard line width) corresponding to the pace run event.

In the example illustrated in FIG. 26, since a training event performed in a third section is walking, the third section is displayed by a visual expression (solid line image) corresponding to the walking event.

In a case where a training event differs for each section, respective sections may also be displayed by different visual expressions in the screen illustrated in FIG. 24 in the same manner as in the screen illustrated in FIG. 26.

Herein, the linear images with different line types and line widths are allocated to different training events, but linear images with different line colors may be allocated to different training events, linear images which blink in different patterns may be allocated to different training events, and linear images with different textures may be allocated to different training events. In other words, curve images with at least one of different line colors, line widths, line types, temporally changing patterns, and textures may be employed as visual expressions for differentiating training events from each other.

Herein, a linear images extending in the horizontal direction when viewed from the user is employed as a visual expression, but visual expressions other than a simple linear image, that is, visual expressions such as tube images, block images, rope images, wire images, ribbon images, arrow marks, block image sequences, and mark images may be employed.

On the display screen, time or a standard distance required for a training event may be reflected in a size of the visual expression (various images) in the display screen. In this case, the user can intuitively understand time or a distance required for a training event on the basis of the length of the visual expression (linear image). Actual time or distance may be reflected in a size of a section in which the user has moved, and scheduled time or scheduled distance may be reflected in a size of a section in which the user will move from now on.

1-27. Gray-Out of Section in which Movement is Completed

In the navigation screens illustrated in FIGS. 24 and 26 and the like, a section in which the user has moved and a section in which the user is to move from now on may be differentiated from each other in a currently being displayed course. In other words, when the user moves on a recommended route, the display section 170 (or the processing section 120) may display a visual expression of a section in which the user has moved on the recommended route as a visual expression which is different from a visual expression of a section in which the user does not move.

For example, the processing section 120 of the electronic apparatus 1 may gray out a section in which the user has moved in a course which is being displayed as illustrated in FIG. 27 so as to emphasize a section in which the user moves from now on. In the example illustrated in FIG. 27, the present position of the user is indicated by an arrow, and, in the currently displayed course, the section in which the user has moved is grayed out with the arrow as a boundary, and the remaining sections are displayed by line types corresponding to training events.

Here, the gray-out is a process of relatively emphasizing an impression of a remaining image by reducing saturation of a partial image displayed on a screen. Here, as a gray-out process, for example, at least one of a process of reducing saturation, a process of reducing contrast, and a process of reducing luminance may be used.

### 1-28. Navigation Screen (Map Display)

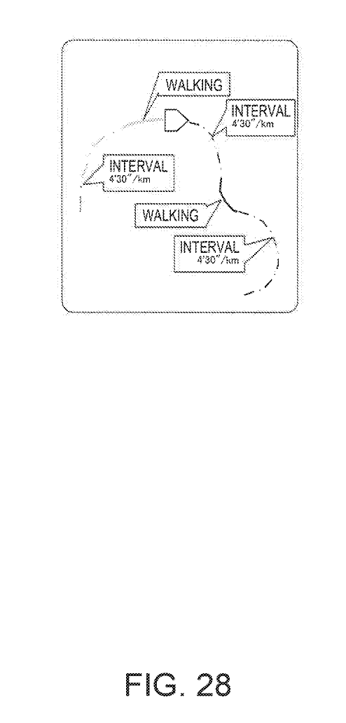

On the above-described navigation screens (FIGS. 24 and 26), a course (recommended course) in which the user performs training is displayed as a linear image or an elevation map, but, for example, as illustrated in FIG. 28, a recommended course may be displayed to overlap a two-dimensional map (in FIG. 28, an element such as a landmark disposed on the map is not displayed in order to emphasize the course). The two-dimensional map mentioned here is a map having a latitude axis and a longitude axis.

Although not illustrated, a three-dimensional map may be used instead of a two-dimensional map. The three-dimensional map has a map having a latitude axis, a longitude axis, and an elevation axis, and may be, for example, a perspective view (bird's-eye view) in which a predetermined area is viewed from one direction, and may be a perspective view (bird's-eye view) in which the viewpoint is variable. Two or more maps, for example, a two-dimensional map and an elevation map may be arranged and displayed together on the navigation screen.

In other words, the display section 170 may display a recommended course on a map in an overlapping manner, and the map may be at least one of, for example, a two-dimensional map including at least a part of a recommended course, a three-dimensional map including at least a part of the recommended course, and a map indicating an elevation of at least a part of a recommended route.

In FIG. 28, the recommended course includes a first section corresponding to a first training event (interval run), a second section corresponding to a second training event (walking), and a third section corresponding to a third training event (interval run). The first section is displayed by a first visual expression (dot chain image) corresponding to the first training event (interval run), the second section is displayed by a second visual expression (solid line image) corresponding to the second training event (walking), and the third section is displayed by a first visual expression (dot chain image) corresponding to the third training event (interval run).

### 1-29. Details of Course Data

Here, a description will be made of the database 350 stored in the storage section 34 of the server 4. FIG. 29 illustrates several items of course data registered in the database 350.

The database 350 is fundamentally stored in the storage section 34 of the server 4. However, at least a part of the database 350 may be written into the storage section 24 of the information terminal 2 via the communication section 32 of the server 4, the network 3, and the communication section 27 of the information terminal 2 as necessary. At least some of the course data written into the storage section 24 of the information terminal 2 may be written into the storage section 130 of the electronic apparatus 1 via the communication section 22 of the information terminal 2 and the communication section 190 of the electronic apparatus 1 as necessary.

The database 350 includes course data of various courses, and course data of each course includes, for example, a course ID of the course (course identification information), a distance of the course (entire length), elevations of respective points forming the course, a position coordinate of a representative point of the course, and a training event appropriate to be performed in the course. In a case where there are a plurality of training events appropriate for a single course, each of the plurality of training events is written into course data. In a case where a training event differs for each section of a single course, a distance of the section is also written into the course data along with the training event.

For example, the processing section 31 of the server 4 refers to position coordinates of respective courses included in the database 350, and selects one or a plurality of courses to which distances from the present position of the user are within a predetermined distance from among the courses. Thereafter, the display section 170 of the electronic apparatus 1 may present at least one course which is present within the predetermined distance from the position of the user before training is started, as a recommended course. In other words, the display section 170 of the electronic apparatus 1 may exclude a course which is not located near the user from candidates of recommended courses.

For example, the processing section 31 of the server 4 may determine a training event appropriate for the user at the present time on the basis of a mental fatigue degree and a physical fatigue degree at the present time of the user, and may select one or a plurality of courses appropriate for the training event from one or a plurality of courses (alternatively, one or a plurality of courses which are not appropriate for the training event are excluded).

Since the content of course data (elevation data) differs in a case where the user moves in a predetermined direction in a certain course and a case where the user moves in an opposite direction in the same course, two items of course data for a single course may be stored in the database 350. However, in a case where a single item of course data for a single course is stored, the processing section 31 of the server 4 may reverse arrangement (reading order) of course data in cases where a movement direction of the user in the course is a positive direction and a negative direction.

The processing section 31 of the server 4 may allocate different recommended events to different section of a recommended course on the basis of a predetermined algorithm (predetermined selection condition) and the database 350. For example, since a course having the course ID 0002 in FIG. 29 is formed of walking of 2 km, and a pace run of 3.8 km, in a case where the course having the course ID 0002 is selected as a recommended course, the processing section 31 of the server 4 may generate a recommended course with a recommended event (so-called a training menu) by allocating training events to respective section of the course so that the following selection conditions (i) and (ii) are satisfied.

(i) A pace run is performed as continuously as possible. (ii) Walking is allocated to a first section and the last section.

In this case, walking is allocated to an initial section of 1 km of the recommended course corresponding to the course ID 0002, a pace run is allocated to a second section of 3.8 km, and walking is allocated to the last section of 1 km.

### 1-30. Flow of Course Recommendation Process

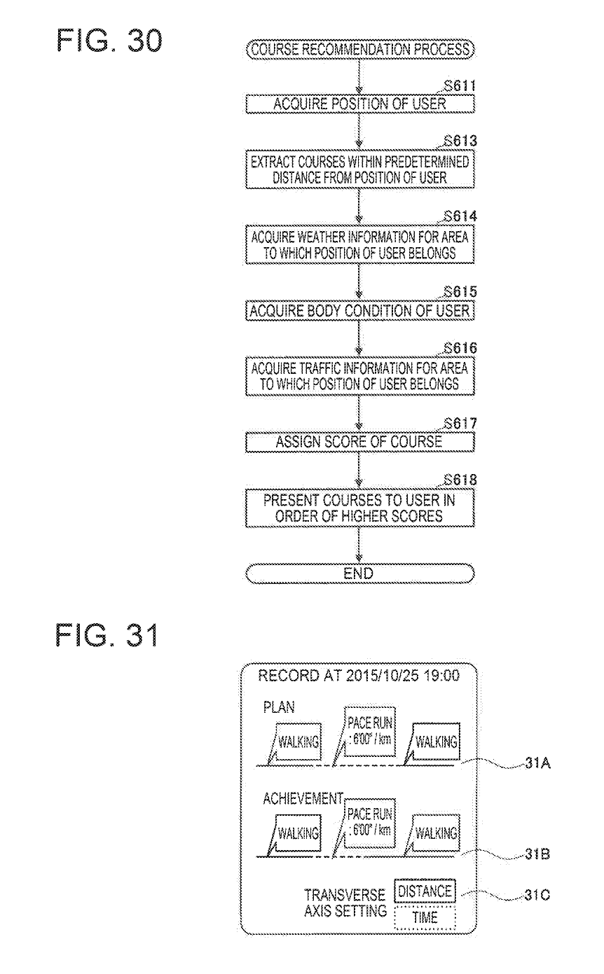

FIG. 30 is a flowchart illustrating an example of a course recommendation process (an example of an information output method) performed by the processing section 31 of the server 4. Herein, a description will be made focusing on an algorithm of selecting a recommended course. It is assumed that, prior to the course recommendation process, log data required to recognize body condition information (a mental fatigue degree and a physical fatigue degree) of a user is transmitted from the information terminal 2 to the server 4, and is added to a log data list 341i corresponding to a user ID=i of the user.

First, the processing section 31 receives information regarding the present position of the user from the information terminal 2 (S611), searches the database 350 on the basis of the present position, and extracts one or a plurality of courses (recommended course candidates) to which distances from the present position are equal to or less than a threshold value (for example, 20 km or less) (S613). A position of each course registered in the database 350 in advance is a representative position of the course. Therefore, herein, it is assumed that a plurality of courses to which distances from the representative position are equal to or less than a threshold value are extracted. Hereinafter, two or more recommended courses are assumed to be extracted. Consequently, a plurality of courses having representative positions in an area (herein, a circular area having a radius of 10 km) to which the present position of the user belongs are extracted.

Next, the processing section 31 acquires weather information for the area to which the present position of the user belongs from a weather server (not illustrated) via the network 3 (S614). The processing section 31 transmits information indicating the present position to the weather server (not illustrated) via the communication section 32 and the network 3, and receives the weather information for the area to which the present position belongs from the weather server via the network 3 and the communication section 32. An area related to weather information preferably includes all of the plurality of courses extracted in step S613. The weather information may include weather forecast information (a distribution of temperature, a temporal change in temperature, a distribution of precipitation, temporal change in precipitation, a distribution of atmospheric pressure, a temporal change in atmospheric pressure) in a predetermined period including the present time and the future. At least one of traffic information and weather information may not be used.

Next, the processing section 31 acquires body condition information (a mental fatigue degree and a physical fatigue degree) of the user at the present time on the basis of the log data list 341i of the user, that is, log data acquired for the user until the present time (S615). A process of acquiring the mental fatigue degree and the physical fatigue degree is the same as described above, and the user may input a mental fatigue degree and a physical fatigue degree in the middle of the process (refer to FIGS. 4 to 7).

Next, the processing section 31 acquires traffic information for the area to which the present position of the user belongs from a traffic server (not illustrated) via the network 3 (S616). The processing section 31 transmits information indicating the present position to the traffic server (not illustrated) via the communication section 32 and the network 3, and receives traffic information for the area to which the present position of the user belongs from the traffic server via the network 3 and the communication section 32. An area related to traffic information preferably includes all of the plurality of courses extracted in step S613. The traffic information may include traffic forecast information (a distribution of congestion degrees, and temporal changes in congestion degrees) in a predetermined period including the present time and the future.

Next, the processing section 31 calculates a score of each of the plurality of courses calculated in step S613 on the basis of the present position, the body condition information, the weather information, and the traffic information (S617). Details of a process of calculating a score will be described later. A score of the course is a recommendation degree for the user.

Next, the processing section 31 generates browsing data or the like of recommended courses on the basis of the score of each of the plurality of courses and the course data (included in the database 350) of the plurality of courses, transmits the browsing data to the information terminal 2 via the communication section 32, the network 3, and the communication section 27, and finishes the flow (S618). The browsing data of recommended courses is obtained by arranging a plurality of courses in the score order (refer to FIGS. 17 to 21 and FIG. 23, and the like). Therefore, the plurality of recommended courses are presented to the user in the score order. In a case where there is a restriction in a display space, and thus all of the recommended courses cannot be presented, the processing section 21 may present recommended courses of a predetermined number with a high score in the score order. In other words, the processing section 31 may present, as a recommended route, a route with a high recommendation degree among two or more routes present within a predetermined distance from a position of the user before activity is started.

In the above-described flow, orders of the steps may be replaced with each other as appropriate.

### 1-31. Score Calculation Process

Hereinafter, a description will be made of a process of calculating a score of a course.

A score of a course is calculated according to, for example, the following Equation (1).

score=−k₁×h+p(d|k₂)−k₃×Nₛ (1)

Here, meanings of the respective parameters in Equation (1) are as follows.

h is an average value of an elevation difference of a course, and is, for example, an absolute value of the larger one of the cumulative ascending altitude and the cumulative descending altitude in the course.

d is a distance of the course, that is, the entire length. The distance d of the course is registered in the database 350 in advance.

Nₛ is the number of points at which a user is to stop in the course, and is, for example, the number of signals disposed in the course.

k₂ is an ideal distance derived from body condition information and weather information. For example, the parameter k₂ is set to be longer as a body condition of the user becomes more favorable (a fatigue degree becomes lower), and is set to be longer as the temperature of the course becomes higher. A body condition used to calculate the parameter k₂ is, for example, a physical fatigue degree, particularly, a fatigue degree (which is determined on the basis of a heart rate or the like during normal times) of the user in the daytime in the recent predetermined period. For example, even under the same body condition, the parameter k₂, that is, an ideal distance is set to 10 km at a temperature of 20° C., and an ideal distance is set to 8 km at a temperature of 25° C.

p(d|k₂) is a value indicating coincidence between the parameter k₂ and the actual distance d of the course, and is, for example, a value p(d|k₂) obtained by assigning the actual distance d to a normal distribution p(k₂) centering on the parameter k₂.

k₁ is an index indicating a physical fatigue degree of the user. For example, the parameter k₁ may be derived from the time required for the user's stair climbing in the recent predetermined period. As the time required for stair climbing is reduced, a score of a course with a great elevation difference becomes higher.

k₃ is an index which is set according to weather information. For example, the parameter k₃ is set to “2” in a case where precipitation is large (rainy), and is set to “1” in a case where precipitation is small (sunny). As the parameter k₃ becomes larger, a score of a course with the number of times of stoppage becomes higher.

Values of the parameters k₁, k₂ and k₃ in Equation (1) also play the role of normalization adjusting a weight of each term in Equation (1). Therefore, the processing section 31 may adjust a magnitude relationship among the parameters k₁, k₂ and k₃ in response to an instruction or the like from the user.

### 1-32. Other Score Calculation Processes

The processing section 31 may calculate a score not only on the basis of a body condition of the user but also on the basis of a recommended training event for the user or a training event selected by the user (hereinafter, these will be collectively referred to as a “training event”).

For example, the processing section 31 may increase a score of a course as coincidence between an inclination level appropriate for a training event and an inclination level of the course becomes higher. It is assumed that the storage section 34 of the processing section 31 stores a value of an optimal inclination level for each training event, and the processing section 31 refers to a value of the inclination level as appropriate.

The processing section 31 may increase a score of a course as coincidence between a distance appropriate for a training event and a distance of the course becomes higher. It is assumed that the storage section 34 of the processing section 31 stores a value of an optimal distance for each training event, and the processing section 31 refers to a value of the distance as appropriate.

The processing section 31 may increase a score of a course as coincidence between a speed appropriate for a training event and a general movement speed in the course becomes higher. It is assumed that the storage section 34 of the processing section 31 stores a value of an optimal speed for each training event, and the processing section 31 refers to a value of the speed as appropriate. It is assumed that the database 350 stores a value of a general movement speed for each training event, and the processing section 31 refers to a value of the speed as appropriate.

The processing section 31 may increase a score of a course as coincidence between an elevation difference appropriate for a training event and an elevation difference of the course becomes higher. It is assumed that the storage section 34 of the processing section 31 stores a value of an optimal elevation difference for each training event, and the processing section 31 refers to a value of the elevation difference as appropriate.

If the processing section 31 determines a score in the above-described way, when the user performs training in a recommended course, it is possible to reduce the risk of injury the user, increase a training effect, and effectively recover the user's fatigue.

### 1-33. Other Event Recommendation Processes

The processing section 31 of the server 4 performs a process of determining a recommended event and a recommended course before training is started, but may perform the process before the training is started, and then may perform the process during training. This is because, for example, a body condition of a user which is not good when training is started, and turns for the better in the middle of the training, and thus a recommended event or a recommended course may be changed.

However, in this case, necessary log data is assumed to be uploaded to the server 4 in order during training via the communication section 190 of the electronic apparatus 1, the communication section 22 and the communication section 27 of the information terminal 2, the network 3, and the communication section 32.

When the user is notified of a recommended event causing a higher load than an initial recommended event, the processing section 31 of the server 4 may change a training menu, for example, by increasing the number of laps of a course instead of changing a recommended course.

Determination of a recommended event or a recommended course during training may be performed by the processing section 120 of the electronic apparatus 1 or the processing section 21 of the information terminal 2 instead of the processing section 31 of the server 4.

### 1-34. Feedback Screen

The processing section 120 of the electronic apparatus 1 changes a display screen of the display section 170 from the above-described navigation screen to a feedback screen after training is completed. The feedback screen mentioned here is a screen for a user comparing a training plan indicating a plan of training with a training achievement indicating an achievement of the training.

FIG. 31 illustrates an example of a feedback screen. A training plan 31A, a training achievement 31B, and a button 31C for axis setting are arranged and displayed on the screen illustrated in FIG. 31.

In FIG. 31, the training plan 31A displays a recommended course presented to a user before training is started with a visual expression (a dashed line image with a standard line width) corresponding to a recommended event, a “pace run”.

The example illustrated in FIG. 31 is an example of a case where a recommended event for a first section of the recommended course is walking (solid line image), a recommended event for a second section of the recommended course is a pace run (a dashed line image with a standard line width), and a recommended event for a third section of the recommended course is walking (solid line image).

The training achievement 31B displays a course in which the user has actually moved from starting of training to completion thereof with a visual expression (a dashed line image with a standard line width) corresponding to a training event, a “pace run”.

The example illustrated in FIG. 31 is an example of a case where walking (solid line image) has been performed in the first section of the course, a pace run (a dashed line image with a standard line width) has been performed in the second section of the course, and walking (solid line image) has been performed in the third section of the course.

In other words, the display section 170 displays at least one course in which training has been performed, and the processing section 120 performs control of displaying at least a part of at least one course with a visual expression corresponding to a training event performed in the part. At least one course may include a first section corresponding to first training and a second section corresponding to second training. The first section may be displayed by a first visual expression corresponding to the type of first training, and the second section may be displayed by a second visual expression corresponding to the type of second training.

Here, in the example illustrated in FIG. 31, since the button 31C for transverse axis setting is set to “distance”, in the training plan 31A and the training achievement 31B, a length of each section is set to a length corresponding to a distance of each section.

Therefore, the user can compare the content of training actually performed by the user with the content of training recommended to the user in detail on the same screen.

If the button 31C for transverse axis setting is changed from “distance” to “time”, in the training plan 31A and the training achievement 31B, a length of each section is changed to a length corresponding to time in each section.

The processing section 120 of the electronic apparatus 1 may generate information regarding the training achievement 31B to be displayed on the feedback screen on the basis of log data acquired during training.

Herein, the feedback screen is displayed on the display section 170 of the electronic apparatus 1, but may be displayed on the display section 25 of the information terminal 2. The feedback screen may be generated by the processing section 120 of the electronic apparatus 1, and may be generated by the processing section 31 of the server 4. In a case where the feedback screen is generated by the processing section 21 of the information terminal 2, it is necessary to transmit log data acquired during training to the information terminal 2 via the communication section 190 of the electronic apparatus 1 and the communication section 22 of the information terminal 2. In a case where the feedback screen is generated by the processing section 31 of the server 4, it is necessary to transmit log data acquired during training to the information terminal 2 via the communication section 190 of the electronic apparatus 1, the communication section 22 of the information terminal 2, the communication section 27 of the information terminal 2, the network 3, and the communication section 32 of the server 4.

At least one course displayed on the feedback screen may include a first course corresponding to first training and a second course which is different from the first course, corresponding to second training. The first course may be displayed by a first visual expression corresponding to an event of the first training, and the second course may be displayed by a second visual expression corresponding to an event of the second training. A display method in a case where a plurality of courses are displayed on a feedback screen is the same as in a case of displaying a plurality of recommended courses, and a plurality of courses may be displayed according to methods or the like in which the plurality of courses are arranged and displayed, a selected courses is displayed, and a plurality of courses are sequentially displayed.

### 1-35. Flow of Event Determination Process (Overall)

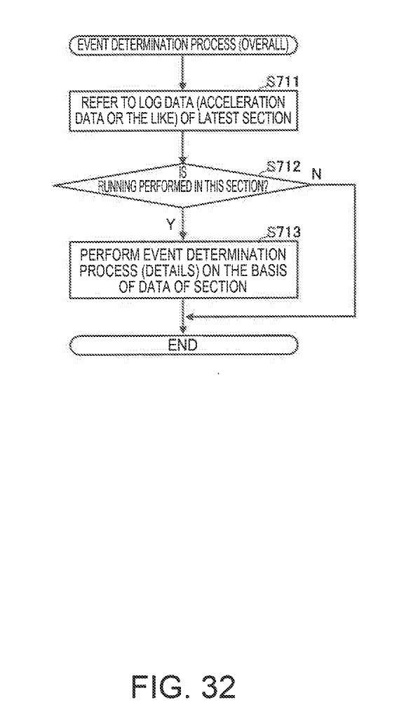

FIG. 32 is a flowchart of a training event determination process (overall).

Herein, it is assumed that the event determination process (overall) is mainly performed by the processing section 120 of the electronic apparatus 1, and the event determination process (overall) is performed during training. However, the event determination process (overall) may be mainly performed by the processing section 21 of the information terminal 2 or the processing section 31 of the server 4, and the event determination process (overall) may be performed after training is performed. However, in a case where the event determination process (overall) is mainly performed by the processing section 21 or the processing section 31, log data acquired during training is assumed to be transmitted to the information terminal 2 or the server 4 via the communication section 190 of the electronic apparatus 1, the communication sections 22 and 27 of the information terminal 2, the network 3, the communication section 32 of the server 4, and the like, during training or after training.

Herein, it is assumed that the flow in FIG. 32 is repeatedly executed by the processing section 120 of the electronic apparatus 1 in a predetermined cycle (herein, a cycle of 5 seconds) after training is started.

First, the processing section 120 of the electronic apparatus 1 refers to log data of the latest section (herein, a section corresponding to last 5 seconds) ($711). The “section” in the description of the flow is a section obtained through time division of a training period, and is different from a section (obtained through distance division) in other descriptions. The log data which is referred to here is log data indicating a motion state of a user and a position of the user, and is, for example, acceleration data output from the acceleration sensor 113, positioning data output from the GPS sensor 110, and atmospheric pressure data output from the atmospheric pressure sensor 112. A log data sampling cycle is a cycle (for example, 1 second or less) shorter than an execution cycle (herein, 5 seconds) of the flow.

Next, the processing section 120 of the electronic apparatus 1 determines whether or not the type of action of the user in this section is “running” on the basis of the log data referred to (S712). In this determination, it is determined whether the type of action is “running”, or “walk” or “stop”.

For example, the processing section 120 performs main component analysis on acceleration data in the section, determines that the action is “running” if the magnitude of a first singular value is equal to or greater than a predetermined value, and a peak frequency (a peak frequency in a Fourier spectrum) of a first main component in FFT is about 1.5 Hz or 3.0 Hz, determines that the action is “walk” if the magnitude of the first singular value is equal to or greater than a predetermined value, and a peak frequency (a peak frequency in a Fourier spectrum) of a first main component in FFT is about 1.0 Hz or 2.0 Hz, and determines that the action is “stop” in other cases.

In a case where the type of action is “walk” or “stop” (S712N), the processing section 120 skips the next step S713 and finishes the flow, and in a case where the type of action “running” (S712Y), the processing section 120 performs the next step S713.

Next, the processing section 120 of the electronic apparatus 1 performs an event determination process (details) in this section so as to determine a training event in this section, and finishes the flow (S713). A training event performed in this section is determined on the basis of log data (for example, a pace and a heart rate) in this section. A flow of the event determination process (details) is as follows.

### 1-36. Flow of Event Determination Process (Details)

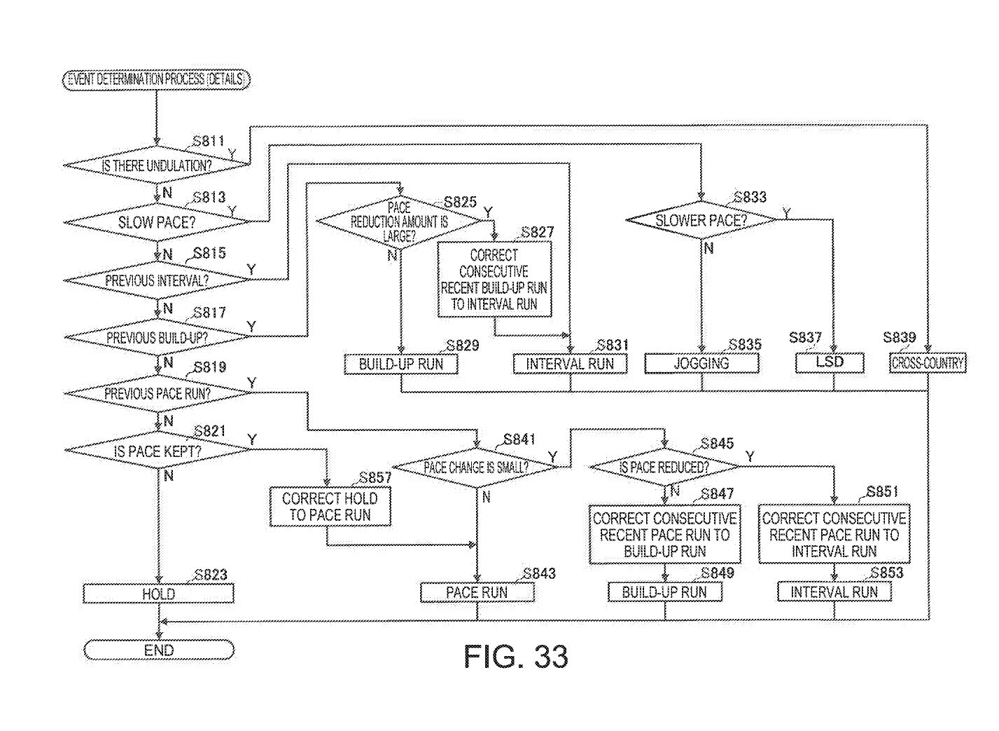

FIG. 33 is a flowchart of the training event determination process (details).

Herein, it is assumed that the event determination process (details) is mainly performed by the processing section 120 of the electronic apparatus 1, and the event determination process (details) is performed during training. However, the event determination process (details) may be mainly performed by the processing section 21 of the information terminal 2 or the processing section 31 of the server 4, and the event determination process (details) may be performed after training is performed. However, in a case where the event determination process (details) is mainly performed by the processing section 21 or the processing section 31, log data (which may herein include at least log data described below) acquired during training is assumed to be transmitted to the information terminal 2 or the server 4 training via the communication section 190 of the electronic apparatus 1, the communication sections 22 and 27 of the information terminal 2, the network 3, the communication section 32 of the server 4, and the like, during training or after training.

Herein, it is assumed that the flow in FIG. 33 is repeatedly executed by the processing section 120 of the electronic apparatus 1 in a predetermined cycle (herein, a cycle of 5 seconds) during training.

In the flow in FIG. 33, training performed in a section for last 5 seconds is determined to be included in any one of five events such as a “build-up run”, an “interval run”, “jogging”, “LSD”, and “cross-country” (steps S829, S831, S835, S837 and S839). However, among the five events, determination of three events such as the “pace run”, the “build-up run”, and the “interval run” cannot be promptly fixed by using only log data for one section, and thus determination results in a plurality of sections are taken into consideration. Thus, a process (S823) of holding a determination result in the latest section, and processes (S841 to S857) of correcting a determination result in a preceding section are inserted into the flow in FIG. 33. Hereinafter, each step will be described.

First, the processing section 120 determines whether or not there is undulation which is equal to or more than a proper inclination level in this section on the basis of data regarding a position and an altitude included in log data for this section (S811). In a case where there is undulation (S811Y), a training event performed in this section is determined as being “cross-country” (S839), and finishes the flow, and, if otherwise (S811N), the flow proceeds to the next determination process.

Next, the processing section 120 determines whether or not a pace in this section is less than a first threshold value (for example, 7′00″/km) on the basis of data regarding the pace included in log data for this section (S813). In a case where the pace in this section is less than the first threshold value (S813Y), the flow proceeds to processes (S833 to S837) of differentiating “jogging” from “LSD”, and, if otherwise (S813N), the flow proceeds to a determination process (S815) based on a determination result in the previous section.

Next, the processing section 120 determines whether or not the previous determination result is an “interval run” (S815). However, since there is no previous determination result in the first step S815, the flow promptly proceeds to the next determination process. In a case where the previous determination result is an “interval run” (S815Y), the processing section 120 also outputs a determination result in this section as an “interval run” (S831), and finishes the flow, and proceeds to the next determination process (S817) if otherwise (S815N).

Next, the processing section 120 determines whether or not the previous determination result is a “build-up run” (S817). However, since there is no previous determination result in the first step S817, the flow promptly proceeds to the next determination process. In a case where the previous determination result is a “build-up run” (S817Y), the processing section 120 proceeds to processes (S825 to S831) of differentiating a “build-up run” from an “interval run”, and proceeds to the next determination process (S819) if otherwise (S817N).

Next, the processing section 120 determines whether or not the previous determination result is a “pace run” (S819). However, since there is no previous determination result in the first step S819, the flow promptly proceeds to the next determination process. In a case where the previous determination result is a “pace run” (S819Y), the processing section 120 proceeds to correction processes (S841 to S853), and proceeds to the next determination process (S821) if otherwise (S819N).

Next, the processing section 120 determines whether or not a pace is kept in a predetermined period T1 on the basis of pace data included in log data in the last predetermined period T1 (for example, two or more sections) (S821). In a case where it is determined that a pace is kept (S821Y), the processing section 120 corrects the determination result “hold” in each section up to the previous time to a “pace run” (S857), then outputs a determination result in this section as a “pace run” (S843), and finishes the flow. On the other hand, in a case where it is determined that a pace is not kept (S821N), the processing section 120 outputs a determination result in this section as “hold” (S823), and finishes the flow.

Next, a description will be made of the processes (S825 to S831) of differentiating a “build-up run” from an “interval run”.

First, the processing section 120 determines whether or not a pace reduction amount in this section using an average pace in sections up to the previous time as a reference is equal to or more than a threshold value (60 seconds/km) (S825), and outputs a determination result in this section as a “build-up run” (S829) in a case where the pace reduction amount is not equal to or more than the threshold value (S825N), and finishes the flow. In a case where the pace reduction amount is equal to or more than the threshold value (S825Y), the processing section 120 corrects the determination result “build-up run” in a section following this section to an “interval run” (S827), then outputs a determination result in this section as an “interval run” (S831), and finishes the flow.

Next, a description will be made of the processes (S833 to S837) of differentiating “jogging” from “LSD”.

First, the processing section 120 determines whether or not a pace in this section is less than a second threshold value (for example, 7′00″/km) smaller than the first threshold value (S833). In a case where the pace in this section is not less than the second threshold value (S833N), a determination result in this section is “jogging” (S835), and, if otherwise (S833Y), a determination result in this section is “LSD” (S837), and the flow is finished.

Next, a description will be made of processes (S841 to S857) of correcting a determination result in a preceding section.

First, the processing section 120 determines whether or not the magnitude of a difference (pace change amount) between an average pace in consecutive sections up to the previous time in which a pace run is determined and a pace in this section is equal to or more than a threshold value (30 seconds/km) (S841), outputs a determination result in this section as a “pace run” (S843) in a case where the magnitude of the pace change amount is not equal to or more than the threshold value (S841N), and finishes the flow.

On the other hand, in a case where the magnitude of the pace change amount is equal to or more than the threshold value (S841Y), the processing section 120 proceeds to a further determination process (S845).

In the further determination process (S845), the processing section 120 determines whether or not an average pace in consecutive sections up to the previous time in which a pace run is determined is slower than a pace in this section (S845).

In a case where it is determined that the average pace is not slower than the pace in this section (S845N), the processing section 120 corrects the determination result “pace run” in the consecutive sections to a “build-up run” (S847), outputs a determination result in this section as a “build-up run” (S849), and finishes the flow.

In a case where it is determined that the average pace is slower than the pace in this section (S845Y), the processing section 120 corrects the determination result “pace run” in the consecutive sections to an “interval run” (S851), outputs a determination result in this section as an “interval run” (S853), and finishes the flow.

As a result of the above flow being repeatedly performed during training, a training event (determination result) performed by the user in each section is fixed. Information regarding the event (determination result) in each section is included in, for example, log data of training, and is transmitted to the server 4 via the communication section 190 of the electronic apparatus 1, the communication section 22 and the communication section 27 of the information terminal 2, the network 3, and the communication section 32 of the server 4 in a predetermined format. The log data is registered in the database 350 of the storage section 34 of the server 4. A format of course data is the same as described above.

### 1-37. Feedback Screen (Circle Graph)

The processing section 120 of the electronic apparatus 1 changes a display screen of the display section 170 from the above-described navigation screen to a feedback screen after training is completed. The feedback screen mentioned here is a screen displaying an achievement of the training.

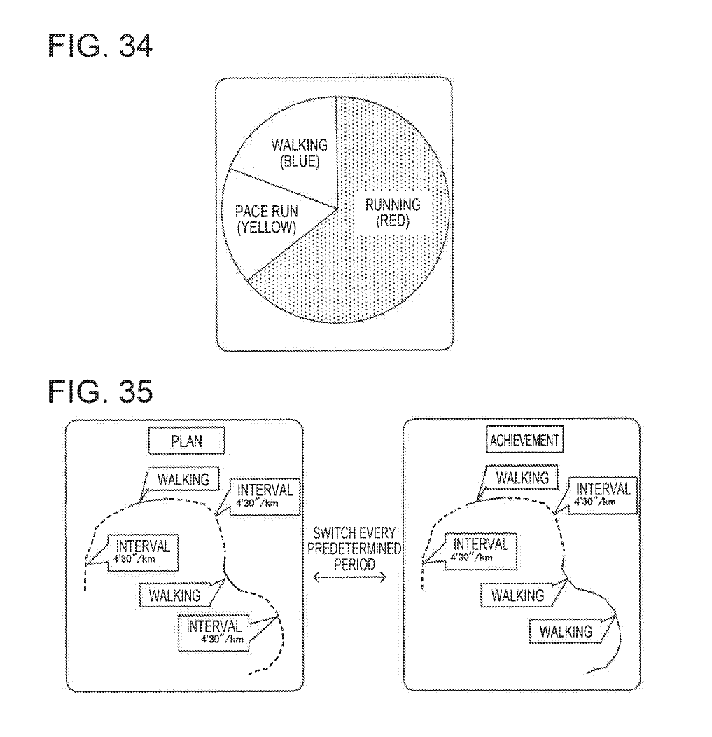

FIG. 34 illustrates an example of training achievements (event-basis graph). Proportions of events performed in training executed once are displayed by a circle graph on the screen illustrated in FIG. 34. A central angle of each region of the circle graph indicates a length of a training time (or distance). FIG. 34 illustrates an example of the circle graph in a case where running, a pace run, and walking are performed in training executed once.

Here, in the circle graph, a fan-shaped region corresponding to the running is displayed by a visual expression (for example, a red hatched pattern) corresponding to the running, a fan-shaped region corresponding to the pace run is displayed by a visual expression (for example, a yellow hatched pattern) corresponding to the pace run, and a fan-shaped region corresponding to the walking is displayed by a visual expression (for example, a blue hatched pattern) corresponding to the walking. As the visual expressions, expressions which can be identified from each other may be used, and, for example, colors, hatched patterns, graphics, or a combination thereof may be used.

Herein, achievements for training executed once are displayed on the feedback screen, but achievements for training executed a plurality of number of times may be displayed. For example, achievements for training for recent one month may be displayed.

### 1-38. Feedback Screen (Map Display)

As illustrated in FIG. 35, map display (refer to FIG. 28) may also be employed in a feedback screen. In other words, the display section 170 may display at least one course in which a user has performed training on a map in an overlapping manner. The map display is a display method in which a course is displayed to overlap a two-dimensional map (a map having a latitude axis and a longitude axis). Also in this case, each section of the course is displayed by a visual expression (or a visual expression corresponding to a recommended event in the section) corresponding to an event performed in the section. The map may be at least one of a two-dimensional map including at least a part of the course, a three-dimensional map including at least a part of the course, and a map indicating an elevation of at least a part of the course (in FIG. 35, an element such as a landmark disposed on the map is not displayed in order to emphasize the course).

When the map display is performed on the feedback screen, the processing section 120 may arrange and display a training plan and a training achievement together, and may cause a display screen to switch between a screen (corresponding to a navigation screen) displaying a training plan and a screen displaying a training achievement as illustrated in FIG. 35. In this case, the processing section 120 may perform switching between display screens every predetermined time (for example, every second), and may perform switching between display screens at a timing at which a user performs a certain action. In a case where there is a restriction in a size as in the display section 170 of the electronic apparatus 1, it is considerably effective to switch between display screens.

### 1-39. Feedback Screen (Elevation Map)

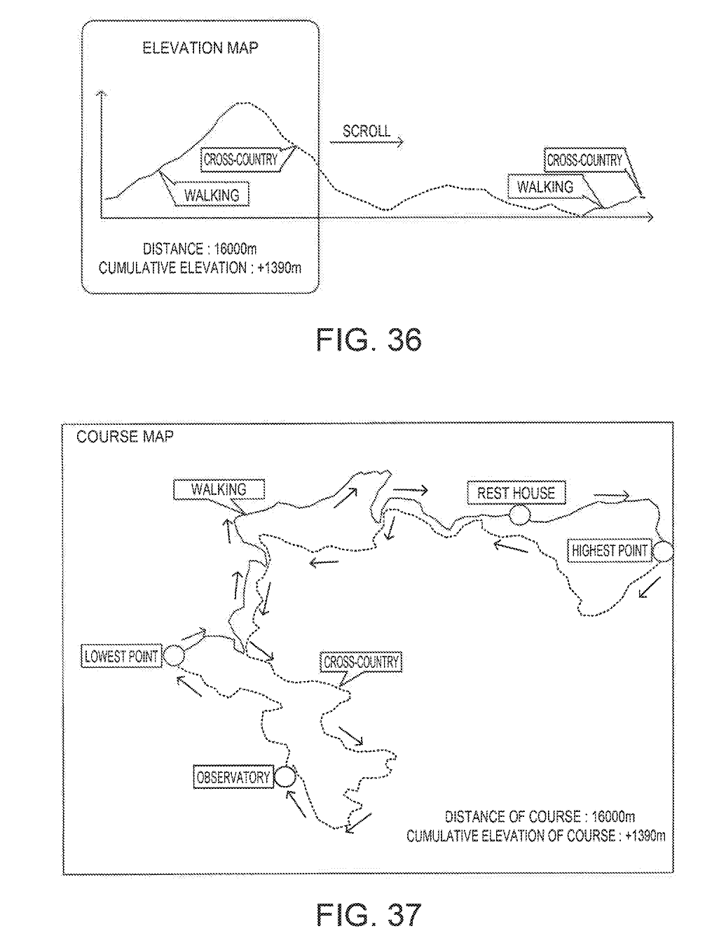

As illustrated in FIG. 36, an elevation map (refer to FIG. 24) may also be employed in a feedback screen. The elevation map is a curve image of a graph in which an elevation coordinate axis is disposed in a vertical direction when viewed from a user, and a position coordinate axis is disposed in a horizontal direction when viewed from the user.

Here, each section of a course illustrated in FIG. 36 is displayed by a visual expression corresponding to a training event performed in the section. In the example illustrated in FIG. 36, most of the sections formed of upward slopes are displayed by a visual expression (solid line image) corresponding to “walking”, and most of the sections formed of downward slopes are displayed by a visual expression (dotted image) corresponding to “cross-country”.

According to the feedback screen, it is possible for a user to verify (review) after the training whether or not a distribution of walking and running in training is appropriate compared with a distribution of slopes of the course. For example, the user can understand a correlation between a slope and a speed in each section of the course, for example, a pace is reduced on an upward slope, and a pace increases on a downward slope.

For example, in a case where a user moves on a marathon course, the processing section 120 may acquire an accumulation result (a numerical value such as a “course finish proportion of 80%”) such as whether or not the user has run all section of the course, and whether or not the user has walked all sections of the course, and may display the accumulation result to the user along with the feedback screen. Such display of the accumulation result may be employed in various feedback screens.

### 1-40. Loop Course

In a case where a course has a loop shape, if the course overlaps on a map, it is difficult to distinguish a course of the second lap transition from the previous course.

Therefore, the processing section 120 of the electronic apparatus 1 may display courses of the second and subsequent laps so that the course is deviated inward of the previous course, or may display courses of different laps in a switching manner every predetermined time (every second). This method is effective, particularly in training on a track.

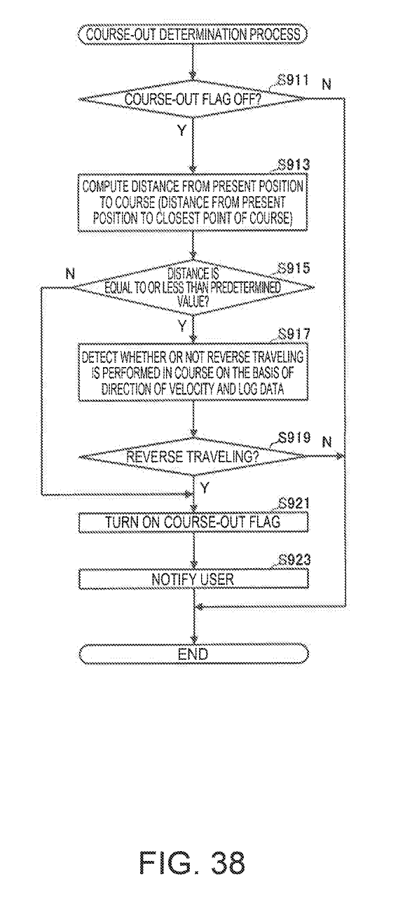

For example, as illustrated in FIG. 37, a user's traveling direction in the course may be displayed on the map (with an arrow mark). FIG. 37 illustrates an example in which the map is displayed on the display section 25 of the information terminal 2 instead of the display section 170 of the electronic apparatus 1. The display section 25 of the information terminal 2 has a smaller restriction in a size than the display section 170 of the electronic apparatus 1, and can thus display a more complicated course (more detailed course shape).

### 1-41. Type Diagnosis

The processing section 31 of the server 4 may diagnose a user's type on the basis of log data (including log data acquired in the latest training) of the user stored in the storage section 34, and may use the diagnosed type for determination of a recommended course performed the next time or determination of a recommended event. The user's type is a tendency of physical ability or a tendency of training, and is, for example, a “stamina type” or a “speed type”.

For example, in a case where the user inputs the type thereof (a distinction between a “stamina type” and a “speed type”) via the operation section 23 of the information terminal 2, the processing section 31 of the server 4 may receive the type from the information terminal 2, and may determine a recommended course or a recommended event appropriate for the type.

### 1-42. Course-Out Determination

The processing section 120 of the electronic apparatus 1 may perform a course-out determination process during display of the above-described navigation screen, and, in a case where a course in which a user actually moves is deviated from a recommended course, the processing section 120 may notify the user of the fact. Hereinafter, a course-out determination process will be described.

FIG. 38 is a flowchart illustrating an example of the course-out determination process. The storage section 24 of the electronic apparatus 1 stores a course-out flag, and the course-out flag is turned on or off as necessary by the processing section 120. The course-out flag is assumed to be in an OFF state when training is started. The following flow is repeatedly performed during training.

First, the processing section 120 refers to the course-out flag, and determines whether or not the course-out flag is in an OFF state (S911). In a case where the course-out flag is in an OFF state (S911Y), the flow proceeds to the next step S913, and the flow is finished if otherwise (S911N).

Next, the processing section 120 computes a distance from the present position of the user to a recommended course, that is, a distance from the present position to the closest point of the recommended course (S913).

Next, the processing section 120 determines whether or not the distance computed in step S913 is equal to or less than a threshold value (S915), proceeds to the next step S917 in a case where the distance is equal to or less than the threshold value (S915Y), and proceeds to step S921 if otherwise (S915N).

Next, the processing section 120 determines whether or not the user reversely travels on the recommended course on the basis of a direction (indicated by a velocity vector included in positioning data, for example) of velocity of the user at the present time and log data (log data other than the velocity vector) until the present time (S917 and S919).

Next, in a case where the user reversely travels (S919Y), the processing section 120 proceeds to step S921, and finishes the flow if otherwise (S919N).

Next, the processing section 120 turns on the course-out flag (S921).

Next, the processing section 120 notifies the user of course-out (S923), and finishes the flow. A notification to the user is performed through, for example, display of an image (including a text image) on the display section 170 or generation of sounds (including vibration) from the sound output section 180. As an aspect of notification, various aspects may be used.

In a case where the course-out flag is turned on, the processing section 120 may automatically stop the above-described navigation function. In this case, for example, the display section 170 may display a recommended course, a recommended event, and the like instead of displaying a navigation screen. Through the display, a user can examine that a course in which training is performed is changed to another course.

### 2. Operations and Effects of Embodiment

As described above, since the system of the present embodiment acquires information regarding a body condition (a physical fatigue degree and a mental fatigue degree) of a user before training (activity) is started, and presents a recommended course and a recommended event recommended to the user as a course (route) and an event in which training is performed on the basis of the body condition information, the user can appropriately select a course and a training event appropriate for the body condition of the user. Consequently, it is possible to support that a user's performance is increased to the maximum, and a risk of injury to the user is minimized.

Since the system of the present embodiment displays at least one recommended course (recommended route) recommended to a user as a course in which training is performed, and displays at least a part of at least one recommended route with a visual expression corresponding to the type (event) of training performed in the part, a user can determine the type (event) of training performed in at least a part of the recommended route on the basis of the visual expression of the part. In other words, the user can easily visually check the type (event) of training to be performed in the part.

Since the system related to the application example performs control of displaying at least one course (route) in which training (activity) is performed, and displaying at least a part of at least one course with a visual expression corresponding to the type (event) of training performed in the part, a user can determine the type of training performed in at least a part of the course on the basis of the visual expression of the part. In other words, the user can easily visually check the type of activity performed in the part.

According to the system of the present embodiment, a user can check a training achievement of the user on a feedback screen, and can thus easily perform not only training but also review after the training is performed. The user can also easily transfer training thereof to other people. The user discloses a feedback screen to an advisor or the like of the user, and can thus easily receive accurate advice on training. The user can easily compare a recommended course or a recommended event presented by the system with a course or an event in which training is performed by the user. Therefore, the user can reduce the time required for analysis of training of the user. Even if the user has less expertise, review of a training menu or reflection in the next training is easy. The user can also improve the training composition skill (menu creation skill) by accumulating reviews.

### 3. Modification Examples

### 3-1. Other Biological Data

The system of the embodiment may further increase the accuracy of a recommended course and a recommended event by using biological data such as a user's blood pressure, brain wave, blood sugar level, body temperature, number of red blood cells, hematocrit, and hemoglobin concentration as log data (items to be recorded) of the user. In a case where it is hard to acquire biological data of the user with sensors, the user may input the biological data prior to training. For example, since it is hard to mount a sensor such as a weight meter on the electronic apparatus 1, data regarding a weight may be manually input by the user or may be acquired through communication with a weight meter. Inputting by the user is performed via the operation section 150 of the electronic apparatus 1, the operation section 23 of the information terminal 2, and the like.

The system of the embodiment may increase the accuracy of a recommended course and a recommended event by using meal data of the user as log data of the user. In a case where it is hard to acquire meal data of the user with sensors, the user may input the meal data prior to training. Inputting by the user is performed via the operation section 150 of the electronic apparatus 1, the operation section 23 of the information terminal 2, and the like.

### 3-2. Expiration Date of Recommended Course or the Like

The processing section 31 of the server 4 may set the expiration date in a recommended course or a recommended event. This is because a body condition of a user changes over time, and thus a recommended course or a recommended event is also changed. In a case where the expiration date has elapsed, the processing section 31 of the server 4, the processing section 21 of the information terminal 2, and the processing section 120 of the electronic apparatus 1 may notify a user of the fact, and may update the recommended course or the recommended event instead of or in addition to the notification.

The time of a notification or update is set on the basis of elapsed time from the acquisition time of log data used to determine the recommended course or the recommended event, elapsed time from the time of presenting the recommended course or the recommended event to the user, and the like.

When a recommended course or a recommended event is presented to the user, the processing section 31 of the server 4 may add a message for the user. The message may be expressed by a sound, an image, or the like.

### 3-3. Recommendation for Each User

The system of the present embodiment may adjust parameters or the like used for a process of determining a recommended course or a recommended event, for example, as follows depending on a user' type. The user's type may be input to the system by the user along with user physical data, and may be automatically determined by the system on the basis of log data of the user.

### (1) Fan Runner

A fan runner is a user whose main purpose is to enjoy running rather than improvement of exercise performance or weight loss. Parameters are adjusted so that a score of a course in which the user usually runs or a score of a course similar thereto is high in order to match the user's taste.

### (2) Athlete

An athlete is a user whose main purpose is to train the body, such as having athlete exercise performance improvement goals or competition participation goals. Parameters are adjusted so that the user's body is gradually trained.

### (3) Person Aiming to Improve Body Condition Through Dieting or the Like

In a case where a mental fatigue degree which is input by a user gradually deteriorates, the user is notified of the fact.

### 3-4. User Setting

In the system, preferably, a user can perform various settings. For example, a user may input a start of a recommended course, or may designate at least some conditions (a geographical condition, the number of signals of a course, climate, an undulation amount, and the like) used to determine a recommended course or a recommended event.

### 3-5. Log Data

In the system, participation achievements (an event, the content, the date and time, results, temperature, climate, and the like) of a sport event of a user may be used as a part of log data when a recommended course or a recommended event is determined. The participation achievements may be input to the system by the user. For example, the system may take into consideration achievements in a sport event in which the user participated right before training when determining a recommended course or a recommended event.

### 3-6. Display of Recommended Course or the Like

In a case where a recommended course or a recommended event is displayed by linear visual expressions (tube images, block images, rope images, wire images, ribbon images, arrow marks, block image sequences, and mark images), a length of the visual expression may be set to a length corresponding to a distance of a recommended course or a recommended event, and may be set to a length corresponding to time of a recommended course or a recommended event.

### 3-7. Other Recommendations

The system determines a recommended course and a recommended event on the basis of log data before training, but may determine a recommended pace on the basis of a heart rate (for example, a heart rate in the previous training) included in log data. The recommended pace is a pace appropriate for cardiorespiratory ability of a user. For example, the system may recommend a moderate pace to a user who is likely to have a high heart rate, and may recommend a steep pace to a user who is unlikely to have a high heart rate.

### 3-8. Sensor Types

The electronic apparatus 1 of the above-described embodiment may use, as a sensor, at least one of the following various sensors. In other words, the various sensors are, for example, an acceleration sensor, a GPS sensor, an angular velocity sensor, a speed sensor, a heartbeat sensor (a chest belt or the like), a pulse sensor (a sensor performing measurement at locations other than the heart), a pedometer, a pressure sensor, an altitude sensor, a temperature sensor (an atmospheric temperature sensor or a body temperature sensor), a geomagnetic sensor, a weight meter (which is used as an external device of the electronic apparatus 1), an ultraviolet sensor, a perspiration sensor, a blood pressure sensor, a blood oxygen concentration (SpO₂) sensor, a lactic acid sensor, and a blood sugar level sensor. The electronic apparatus 1 may include other sensors.

### 3-9. Notification Aspects

The electronic apparatus 1 or the information terminal 2 may perform a notification of information for a user through image display, may perform a notification through sound output or by using vibration, light, or a color (light emission from an LED or a display color of a display), and may perform a notification through a combination of at least two of image display, sound output, vibration, light, and a color.

### 3-10. Customizing

At least some of the notification content (including a notification period, a notification item, a notification aspect, a collecting method, a notification order, and the like) for a user in the system of the embodiment may be set in advance by a user (customizable).

### 3-11. Forms of Apparatus

At least one of the electronic apparatus 1 or the information terminal 2 may be configured as portable information apparatuses of various types, such as a wrist type electronic apparatus, an earphone type electronic apparatus, a ring type electronic apparatus, a pendant type electronic apparatus, an electronic apparatus attached to a sport appliance and used, a smart phone, a head mounted display (HMD), and a head up display (HUD).

### 3-12. Data Display (Collecting Method)

As a method of collecting data of which the system notifies a user, various methods may be employed. For example, the data may be an average in a predetermined, the best value, the worst value, a cumulative value, a change (graph), a target, an achievement level, a variation (large or small fluctuation), a proportion, an expected value (the time required to run a predetermined distance or a distance which a user can run for a predetermined time) calculated from a measured value of a parameter, and evaluation of activity (a score, a favorable proportion, or the like).

### 3-13. Expression Method

An expression method when the system notifies a user of data may employ at least one of the following methods.

(1) Express a change with a line graph
(2) A bar graph
(3) A numerical value table (which may be scrolled)
(4) Arrangement and display of a target and a result, a result and expectation, and the maximum, the minimum, and an average with respect to a certain item
(5) Change of display when satisfying the predetermined condition, for example, change of a color (black-white inversion, emphasis with different character colors or background colors, or the like), change of the way of display (display or blinking of a predetermined mark, or use of characters larger than during normal times).

### 3-14. Optional Functions

Other functions may be installed in at least one of the electronic apparatus 1 and the information terminal 2. Other functions may be, for example, well-known smart phone functions. The smart phone functions include, for example, a call function, a mail incoming notification function, a call incoming notification function, a communication function, and a camera function.

### 3-15. Events

Events treated by the system of the present embodiment are not limited to the above-described events. For example, the events may be not only marathon, running, and walking, but also climbing, tracking, race walking, skiing (including cross country skiing, ski jumping, and the like), snowboarding, snowshoe hiking, biking, swimming, triathlon, skating, motorcycling, swimming, trail running, golf, tennis, baseball, football, motor sports, boating, yachting, paragliding, kiting, and dog sledding. Courses or training events are not required to be presented for all of the above-described events, and may be presented for at least one sport event treated by the system.

### 3-16. System Application

The system of the present embodiment is also applicable to not only sports but also fitness diet, navigation, and rehabilitation. Any case can be said to correspond to activity of moving the body. In the system of the present embodiment, different items may be logged depending on each application, and a user may select an application.

### 3-17. System Form

In the system of in the above-described embodiment, some of the functions of the server 4 may be installed in the information terminal 2 or the electronic apparatus 1, and some of the functions of the information terminal 2 or the electronic apparatus 1 may be installed in the server 4. In the above-described embodiment, some or all of the functions of the electronic apparatus 1 may be installed in the information terminal 2, some or all of the functions of the server 4 and the information terminal 2 may be installed in the electronic apparatus 1, and some or all of the functions of the server 4 and the electronic apparatus 1 may be installed in the information terminal 2. A plurality of electronic apparatuses cooperate with each other through communication so as to realize some or all of the functions of the system of the above-described embodiment.

In other words, the system of the present embodiment may have any one of the following forms.

(1) Electronic apparatus (wrist apparatus)+information terminal (smart phone or PC)+network+server
(2) Information terminal (smart phone or PC)+network+server
(3) Electronic apparatus (wrist apparatus)+network+server
(4) Electronic apparatus (wrist apparatus standalone)
(5) Information terminal (standalone)
(6) Cooperation between electronic apparatuses in any one of the above cases

### 3-18. Positioning System

In the above-described embodiment, as a global satellite positioning system, a global positioning system is used, but a global navigation satellite system (GNSS) may be used. For example, one or two or more of satellite positioning systems such as a quasi zenith satellite system (QZSS), a global navigation satellite system (GLONASS), GALILEO, a BeiDou navigation satellite system (BeiDou) may be used. As at least one of the satellite positioning systems, a satellite-based augmentation system (SBAS) such as European geostationary-satellite navigation overlay service (EGNOS) or a wide area augmentation system (WAAS) may be used.

### 4. Others

The invention is not limited to the above-described embodiment, and may be variously modified within the scope of the spirit of the invention.

The above-described embodiment and modification examples are only examples, and the invention is not limited thereto. For example, the embodiment and the respective modification examples may be combined with each other as appropriate.

The invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

What is claimed is:

1. An information output system comprising:
a display section that displays at least one geographic route along which a physical activity has been performed by a user of the information output system; and
a processor that performs control of displaying at least a part of the at least one geographic route with a visual expression corresponding to a type of the physical activity performed in the part, different visual expressions being used to indicate different types of physical activity.

2. The information output system according to claim 1,
wherein the at least one geographic route includes a first route corresponding to a first physical activity and a second route, different from the first route, corresponding to a second physical activity,
wherein the first route is displayed by a first visual expression corresponding to the type of the first physical activity, and
wherein the second route is displayed by a second visual expression corresponding to the type of the second physical activity.

3. The information output system according to claim 1,
wherein the at least one geographic route includes a first section corresponding to a first physical activity and a second section corresponding to a second physical activity,
wherein the first section is displayed by a first visual expression corresponding to the type of the first physical activity, and
wherein the second section is displayed by a second visual expression corresponding to the type of the second physical activity.

4. The information output system according to claim 1,
wherein the display section displays at the least one geographic route on a map in an overlapping manner.

5. The information output system according to claim 4,
wherein the map is at least one of a two-dimensional map including at least a part of the at least one geographic route, a three-dimensional map including at least a part of the at least one geographic route, and a map indicating an elevation of at least a part of the at least one geographic route.

6. An information output method comprising:
displaying at least one geographic route along which a physical activity has been performed by a user of the information output method; and
performing control of displaying at least a part of the at least one geographic route with a visual expression corresponding to a type of the physical activity performed in the part, different visual expressions being used to indicate different types of physical activity.

7. An information output program, stored on a non-transitory computer-readable medium, the program causing a computer to execute:
displaying at least one geographic route along which a physical activity has been performed by a user of the information output program; and
performing control of displaying at least a part of the at least one geographic route with a visual expression corresponding to a type of the physical activity performed in the part, different visual expressions being used to indicate different types of physical activity.

8. The information output system according to claim 1, the different visual expressions comprising at least one of different line colors, different line widths, different line types, different temporally changing patterns, or different textures.

9. The information output system according to claim 1, the display section further displaying at least one recommended geographic route based on a present position of the user that has been transmitted to the processor before the physical activity has been performed by the user.

10. The information output system according to claim 9, the display section further displaying at least one recommended physical activity based on a body condition of the user that has been transmitted to the processor before the physical activity has been performed by the user.

11. An information output system comprising a server that:
receives body condition information of a user;
receives information indicating a present position of the user;
determines at least one recommended geographic route and at least one recommended physical activity based on the received body condition information and the received present position information; and
transmits information of the determined at least one recommended geographic route and the determined at least one recommended physical activity to an information terminal, causing at least a part of the at least one geographic route to be displayed on the information terminal with a visual expression corresponding to a type of the physical activity performed in the part, different visual expressions being used to indicate different types of physical activity.

12. The information output system according to claim 11, the different visual expressions comprising at least one of different line colors, different line widths, different line types, different temporally changing patterns, and different textures.

13. The information output system according to claim 11, the body condition information comprising data from a sensor.

14. The information output system according to claim 11, the body condition information comprising log data regarding the user's life, accumulated for a predetermined period of time before being received by the server.

15. The information output system according to claim 14, the predetermined period of time being at least a week.

16. The information output system according to claim 11, the information output system causing display of a mark on the information terminal that changes according to movement of the user along the at least one recommended geographic route.

17. The information output system according to claim 11, the information output system causing display of a section of the geographic route along which the user has already moved to be displayed with a different visual representation than what was displayed prior to the user's movement along that section.
